(19) United States
(12) Patent Application Publication
(10) Pub. No.: US 2023/0236702 A1
(43) Pub. Date: Jul. 27, 2023

(54) Transparent Application Overlay

(71) Applicant: Citrix Systems, Inc., Fort Lauderdale, FL (US)

(72) Inventors: Manbinder Pal Singh, Coral Springs, FL (US); James Bulpin, Coral Springs, FL (US); Christopher Fleck, Boca Raton, FL (US)

(21) Appl. No.: 17/583,724

(22) Filed: Jan. 25, 2022

(51) Int. Cl. G06F 3/0481; G06F 3/0354; G06F 3/04842

(52) U.S. Cl. CPC G06F 3/0481; G06F 3/0354; G06F 3/04842

(57) ABSTRACT

Methods and systems for transparent user-interfaces are described herein. A computing device may generate an overlay that is transparent and positionable on top of a window of a user interface. The overlay may include visible content of an application different than another application of the window. Based on the visible content of the application and content of the another application, the computing device may determine a location of the overlay relative to the window. The computing device may provide, based on the determined location, the overlay on top of the window, so as to display the visible content of the application in a nonoverlapping fashion with the content of the another application to display and enable use of multiple applications with one window.

### FIELD

Aspects described herein generally relate to computer networking, remote computer access, cloud computing systems, and hardware and software related thereto. More specifically, one or more aspects describe herein provide improved user interface techniques, and in some embodiments provide a user interface having a transparent or semi-transparent appearance.

### BACKGROUND

A window refers to an area on a user interface that displays information for a specific program such as an application. A window may be manipulated (e.g., opened, closed, resized, minimized, or moved) on the user interface by a user. Users often use windows to access the content of the applications. Different applications are often shown in multiple windows of a display.

### SUMMARY

The following presents a simplified summary of various aspects described herein. This summary is not an extensive overview, and is not intended to identify required or critical elements or to delineate the scope of the claims. The following summary merely presents some concepts in a simplified form as an introductory prelude to the more detailed description provided below.

Users often desire to view more than one window on a screen, but often must switch between the windows to view content of different applications. Moreover, application windows are often opaque such that one cannot view what is behind the window. Thus, multiple windows, can be cumbersome and inconvenient for users to use and interface with because of limited area within a display in which to present the windows. For example, a user may need to resize two windows to view them side by side so that the user can see content within each window at the same time. This often involves manual manipulation of the windows themselves, or providing additional commands to arrange the various windows. In some instances, such an adjustment is not possible. The windows instead overlap one another so that content of one window is blocked or otherwise obscured by the other window. These window adjustments may take a significant amount of time and some content in the windows (e.g., content in the landscape direction) may still be hidden due to, for example, the size of the screen. Thus, there remains a need to improve display of multiple windows on a user interface which provides ready and convenient access to application content that users desire.

To overcome limitations described above, and to overcome other limitations that will be apparent upon reading and understanding the present specification, aspects described herein are directed towards a transparent application overlay (e.g., a user interface simulating a transparent appearance) on a user interface of a computing device.

In an illustrative embodiment, a first method may be provided for a transparent application overlay. In the first method, a computing device may generate an overlay that is transparent and positionable on top of a window of a user interface. The overlay may include visible content of an application different than another application of the window. Based on the visible content of the application and content of the another application, the computing device may determine a location of the overlay relative to the window. The computing device may provide, based on the determined location, the overlay on top of the window, so as to display the visible content of the application in a nonoverlapping fashion with the content of the another application to display and enable use of multiple applications with one window.

In an illustrative embodiment, a second method may be provided for a transparent application overlay. In the second method, a computing device may determine a location of an overlay on top of a window displayed within a user interface based on content of an application accessible via the overlay and based on content of another application different from the application. The window may include the content of the another application. The computing device may provide the overlay at the determined location. The overlay may be transparent and include the content of the application. The computing device may receive an input on the overlay. The received input may be intended for an element of the content of the another application displayed within the window and visible through the overlay. The computing device may determine an element of the content of the another application based on the received input. The computing device may provide an instruction to the another application, the instruction to replicate an input received on the determined element of the content of the another application to initiate the another application to perform an action.

In an illustrative embodiment, an apparatus may be provided for a transparent application overlay. The apparatus may comprise one or more processors; and memory storing instructions that, when executed by the one or more processors, cause the apparatus to generate an overlay that is transparent and positionable on top of a window of a user interface. The overlay may include visible content of an application different than another application of the window. The instructions, when executed by the one or more processors, cause the apparatus to determine a location of the overlay relative to the window based on the visible content of the application and content of the another application. The instructions, when executed by the one or more processors, cause the apparatus to provide, based on the determined location, the overlay on top of the window, so as to display the visible content of the application in a nonoverlapping fashion with the content of the another application to display and enable use of multiple applications with one window.

In an embodiment of the present disclosure, one or more non-transitory computer readable media may be provided to perform one or more of the processes described herein.

These and additional aspects will be appreciated with the benefit of the disclosures discussed in further detail below.

### BRIEF DESCRIPTION OF THE DRAWINGS

A more complete understanding of aspects described herein and the advantages thereof may be acquired by referring to the following description in consideration of the accompanying drawings, in which like reference numbers indicate like features, and wherein:

FIG. 1 depicts an illustrative computer system architecture that may be used in accordance with one or more illustrative aspects described herein.

FIG. 2 depicts an illustrative remote-access system architecture that may be used in accordance with one or more illustrative aspects described herein.

FIG. 3 depicts an illustrative virtualized system architecture that may be used in accordance with one or more illustrative aspects described herein.

FIG. 4 depicts an illustrative cloud-based system architecture that may be used in accordance with one or more illustrative aspects described herein.

FIG. 5A is a block diagram of an example system in which resource management services may manage and streamline access by clients to resource feeds (via one or more gateway services) and/or software-as-a-service (SaaS) applications.

FIG. 5B is a block diagram showing an example implementation of the system shown in FIG. 5A in which various resource management services as well as a gateway service are located within a cloud computing environment.

FIG. 6 depicts an example user interface for application transparency settings that may be used in accordance with one or more illustrative aspects described herein.

FIGS. 7A-7D depict example transparent application overlay windows that may be used in accordance with one or more illustrative aspects described herein.

FIGS. 8A-8B depict a flowchart showing an example method for providing and managing a transparent application that may be used in accordance with one or more illustrative aspects described herein.

### DETAILED DESCRIPTION

In the following description of the various embodiments, reference is made to the accompanying drawings identified above and which form a part hereof, and in which is shown by way of illustration various embodiments in which aspects described herein may be practiced. It is to be understood that other embodiments may be utilized and structural and functional modifications may be made without departing from the scope described herein. Various aspects are capable of other embodiments and of being practiced or being carried out in various different ways.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “connected,” “coupled,” and similar terms, is meant to include both direct and indirect mounting, connecting, coupling, positioning and engaging.

Computing Architecture

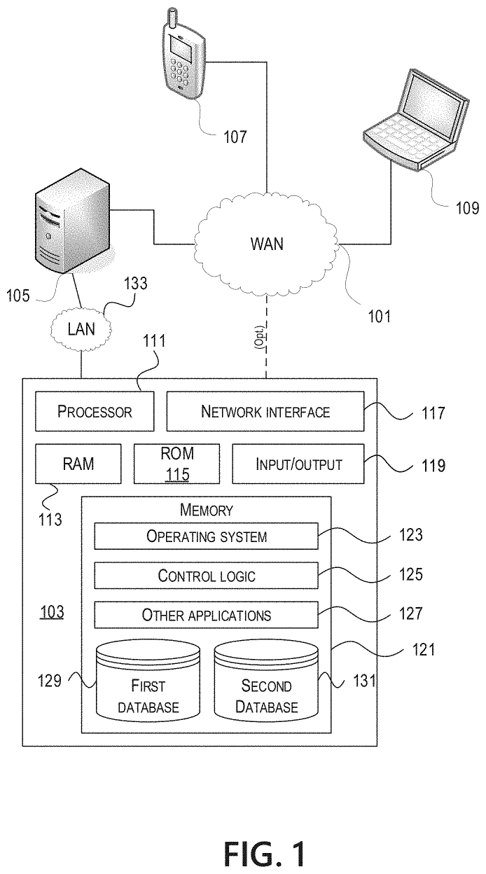

Computer software, hardware, and networks may be utilized in a variety of different system environments, including standalone, networked, remote-access (also known as remote desktop), virtualized, and/or cloud-based environments, among others. FIG. 1 illustrates one example of a system architecture and data processing device that may be used to implement one or more illustrative aspects described herein in a standalone and/or networked environment. Various network nodes 103, 105, 107, and 109 may be interconnected via a wide area network (WAN) 101, such as the Internet. Other networks may also or alternatively be used, including private intranets, corporate networks, local area networks (LAN), metropolitan area networks (MAN), wireless networks, personal networks (PAN), and the like. Network 101 is for illustration purposes and may be replaced with fewer or additional computer networks. A local area network 133 may have one or more of any known LAN topology and may use one or more of a variety of different protocols, such as Ethernet. Devices 103, 105, 107, and 109 and other devices (not shown) may be connected to one or more of the networks via twisted pair wires, coaxial cable, fiber optics, radio waves, or other communication media.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data—attributable to a single entity—which resides across all physical networks.

The components may include data server 103, web server 105, and client computers 107, 109. Data server 103 provides overall access, control and administration of databases and control software for performing one or more illustrative aspects describe herein. Data server 103 may be connected to web server 105 through which users interact with and obtain data as requested. Alternatively, data server 103 may act as a web server itself and be directly connected to the Internet. Data server 103 may be connected to web server 105 through local area network 133, wide area network 101 (e.g., the Internet), via direct or indirect connection, or via some other network. Users may interact with the data server 103 using remote computers 107, 109, e.g., using a web browser to connect to data server 103 via one or more externally exposed web sites hosted by web server 105. Client computers 107, 109 may be used in concert with data server 103 to access data stored therein, or may be used for other purposes. For example, from client device 107 a user may access web server 105 using an Internet browser, as is known in the art, or by executing a software application that communicates with web server 105 and/or data server 103 over a computer network (such as the Internet).

Servers and applications may be combined on the same physical machines, and retain separate virtual or logical addresses, or may reside on separate physical machines. FIG. 1 illustrates just one example of a network architecture that may be used, and those of skill in the art will appreciate that the specific network architecture and data processing devices used may vary, and are secondary to the functionality that they provide, as further described herein. For example, services provided by web server 105 and data server 103 may be combined on a single server.

Each component 103, 105, 107, 109 may be any type of known computer, server, or data processing device. Data server 103, e.g., may include a processor 111 controlling overall operation of the data server 103. Data server 103 may further include random access memory (RAM) 113, read only memory (ROM) 115, network interface 117, input/output interfaces 119 (e.g., keyboard, mouse, display, printer, etc.), and memory 121. Input/output (I/O) 119 may include a variety of interface units and drives for reading, writing, displaying, and/or printing data or files. Memory 121 may further store operating system software 123 for controlling overall operation of data processing device 103, control logic 125 for instructing data server 103 to perform aspects described herein, and other application software 127 providing secondary, support, and/or other functionality which may or might not be used in conjunction with aspects described herein. Control logic 125 may also be referred to herein as data server software 125. Functionality of data server software 125 may refer to operations or decisions made automatically based on rules coded into control logic 125, made manually by a user providing input into the system, and/or a combination of automatic processing based on user input (e.g., queries, data updates, etc.).

Memory 121 may also store data used in performance of one or more aspects described herein, including a first database 129 and a second database 131. In some embodiments, first database 129 may include second database 131 (e.g., as a separate table, report, etc.). That is, the information can be stored in a single database, or separated into different logical, virtual, or physical databases, depending on system design. Devices 105, 107, and 109 may have similar or different architecture as described with respect to device 103. Those of skill in the art will appreciate that the functionality of data processing device 103 (or device 105, 107, or 109) as described herein may be spread across multiple data processing devices, for example, to distribute processing load across multiple computers, to segregate transactions based on geographic location, user access level, quality of service (QoS), etc.

One or more aspects may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HyperText Markup Language (HTML) or Extensible Markup Language (XML). The computer executable instructions may be stored on a computer readable medium such as a nonvolatile storage device. Any suitable computer readable storage media may be utilized, including hard disks, CD-ROMs, optical storage devices, magnetic storage devices, solid state storage devices, and/or any combination thereof. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). Various aspects described herein may be embodied as a method, a data processing system, or a computer program product. Therefore, various functionalities may be embodied in whole or in part in software, firmware, and/or hardware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

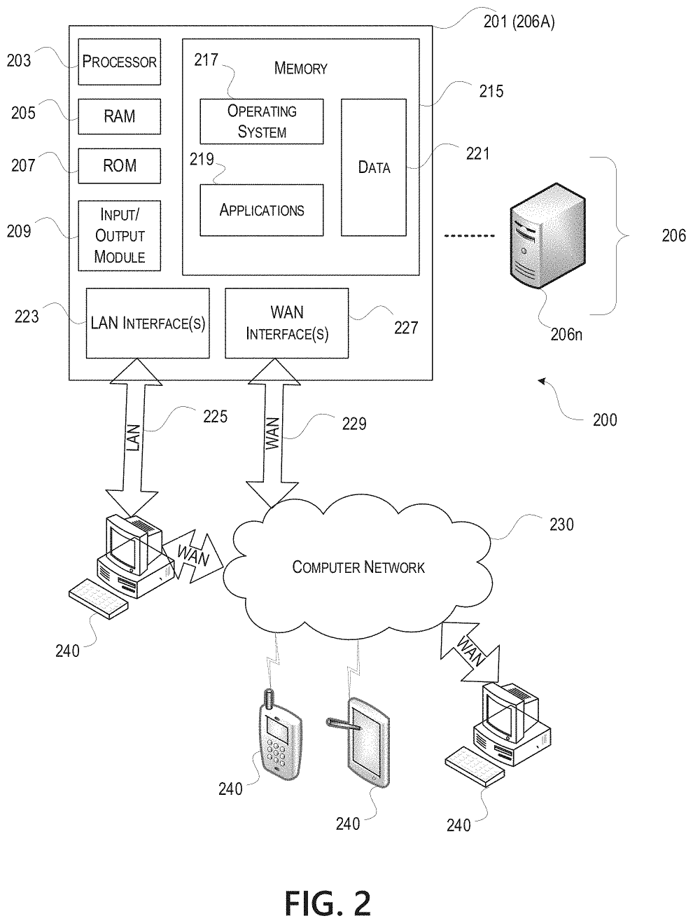

With further reference to FIG. 2, one or more aspects described herein may be implemented in a remote-access environment. FIG. 2 depicts an example system architecture including a computing device 201 in an illustrative computing environment 200 that may be used according to one or more illustrative aspects described herein. Computing device 201 may be used as a server 206a in a single-server or multi-server desktop virtualization system (e.g., a remote access or cloud system) and can be configured to provide virtual machines for client access devices. Computing device 201 may have a processor 203 for controlling overall operation of computing device 201 and its associated components, including RAM 205, ROM 207, Input/Output (I/O) module 209, and memory 215.

I/O module 209 may include a mouse, keypad, touch screen, scanner, optical reader, and/or stylus (or other input device(s)) through which a user of computing device 201 may provide input, and may also include one or more of a speaker for providing audio output and one or more of a video display device for providing textual, audiovisual, and/or graphical output. Software may be stored within memory 215 and/or other storage to provide instructions to processor 203 for configuring computing device 201 into a special purpose computing device in order to perform various functions as described herein. For example, memory 215 may store software used by computing device 201, such as an operating system 217, application programs 219, and an associated database 221.

Computing device 201 may operate in a networked environment supporting connections to one or more remote computers, such as terminals 240 (also referred to as client devices and/or client machines). Terminals 240 may be personal computers, mobile devices, laptop computers, tablets, or servers that include many or all of the elements described above with respect to computing device 103 or 201. The network connections depicted in FIG. 2 include a local area network (LAN) 225 and a wide area network (WAN) 229, but may also include other networks. When used in a LAN networking environment, computing device 201 may be connected to LAN 225 through a network interface or adapter 223. When used in a WAN networking environment, computing device 201 may include a modem or other wide area network interface 227 for establishing communications over the WAN 229, such as computer network 230 (e.g., the Internet). It will be appreciated that the network connections shown are illustrative and other means of establishing a communications link between the computers may be used. Computing device 201 and/or terminals 240 may also be mobile terminals (e.g., mobile phones, smartphones, personal digital assistants (PDAs), notebooks, etc.) including various other components, such as a battery, speaker, and antennas (not shown).

Aspects described herein may also be operational with numerous other general purpose or special purpose computing system environments or configurations. Examples of other computing systems, environments, and/or configurations that may be suitable for use with aspects described herein include, but are not limited to, personal computers, server computers, hand-held or laptop devices, multiprocessor systems, microprocessor-based systems, set top boxes, programmable consumer electronics, network personal computers (PCs), minicomputers, mainframe computers, distributed computing environments that include any of the above systems or devices, and the like.

As shown in FIG. 2, one or more client devices 240 may be in communication with one or more servers 206a-206n (generally referred to herein as “server(s) 206”). In one embodiment, the computing environment 200 may include a network appliance installed between server(s) 206 and client machine(s) 240. The network appliance may manage client/server connections, and in some cases can load balance client connections amongst a plurality of backend servers 206.

The client machine(s) 240 may in some embodiments be referred to as a single client machine 240 or a single group of client machines 240, while server(s) 206 may be referred to as a single server 206 or a single group of servers 206. In one embodiment a single client machine 240 communicates with more than one server 206, while in another embodiment a single server 206 communicates with more than one client machine 240. In yet another embodiment, a single client machine 240 communicates with a single server 206.

A client machine 240 can, in some embodiments, be referenced by any one of the following non-exhaustive terms: client machine(s); client(s); client computer(s); client device(s); client computing device(s); local machine; remote machine; client node(s); endpoint(s); or endpoint node(s). The server 206, in some embodiments, may be referenced by any one of the following non-exhaustive terms: server(s), local machine; remote machine; server farm(s), or host computing device(s).

In one embodiment, client machine 240 may be a virtual machine. The virtual machine may be any virtual machine, while in some embodiments the virtual machine may be any virtual machine managed by a Type 1 or Type 2 hypervisor, for example, a hypervisor developed by Citrix Systems, IBM, VMware, or any other hypervisor. In some aspects, the virtual machine may be managed by a hypervisor, while in other aspects the virtual machine may be managed by a hypervisor executing on a server 206 or a hypervisor executing on a client 240.

Some embodiments include a client device 240 that displays application output generated by an application remotely executing on a server 206 or other remotely located machine. In these embodiments, client device 240 may execute a virtual machine receiver program or application to display the output in an application window, a browser, or other output window. In one example, the application is a desktop, while in other examples the application is an application that generates or presents a desktop. A desktop may include a graphical shell providing a user interface for an instance of an operating system in which local and/or remote applications can be integrated. Applications, as used herein, are programs that execute after an instance of an operating system (and, optionally, also the desktop) has been loaded.

Server 206, in some embodiments, uses a remote presentation protocol or other program to send data to a thin-client or remote-display application executing on the client to present display output generated by an application executing on server 206. The thin-client or remote-display protocol can be any one of the following non-exhaustive list of protocols: the Independent Computing Architecture (ICA) protocol developed by Citrix Systems, Inc. of Ft. Lauderdale, Fla.; or the Remote Desktop Protocol (RDP) manufactured by the Microsoft Corporation of Redmond, Wash.

A remote computing environment may include more than one server 206a-206n such that the servers 206a-206n are logically grouped together into a server farm 206, for example, in a cloud computing environment. Server farm 206 may include servers 206 that are geographically dispersed while logically grouped together, or servers 206 that are located proximate to each other while logically grouped together. Geographically dispersed servers 206a-206n within a server farm 206 can, in some embodiments, communicate using a WAN (wide), MAN (metropolitan), or LAN (local), where different geographic regions can be characterized as: different continents; different regions of a continent; different countries; different states; different cities; different campuses; different rooms; or any combination of the preceding geographical locations. In some embodiments server farm 206 may be administered as a single entity, while in other embodiments server farm 206 can include multiple server farms.

In some embodiments, a server farm may include servers 206 that execute a substantially similar type of operating system platform (e.g., WINDOWS, UNIX, LINUX, iOS, ANDROID, etc.) In other embodiments, server farm 206 may include a first group of one or more servers that execute a first type of operating system platform, and a second group of one or more servers that execute a second type of operating system platform.

Server 206 may be configured as any type of server, as needed, e.g., a file server, an application server, a web server, a proxy server, an appliance, a network appliance, a gateway, an application gateway, a gateway server, a virtualization server, a deployment server, a Secure Sockets Layer (SSL) VPN server, a firewall, a web server, an application server or as a master application server, a server executing an active directory, or a server executing an application acceleration program that provides firewall functionality, application functionality, or load balancing functionality. Other server types may also be used.

Some embodiments include a first server 206a that receives requests from a client machine 240, forwards the request to a second server 206b (not shown), and responds to the request generated by client machine 240 with a response from second server 206b (not shown.) First server 206a may acquire an enumeration of applications available to client machine 240 as well as address information associated with an application server 206 hosting an application identified within the enumeration of applications. First server 206a can then present a response to the client's request using a web interface, and communicate directly with client 240 to provide client 240 with access to an identified application. One or more clients 240 and/or one or more servers 206 may transmit data over network 230, e.g., network 101.

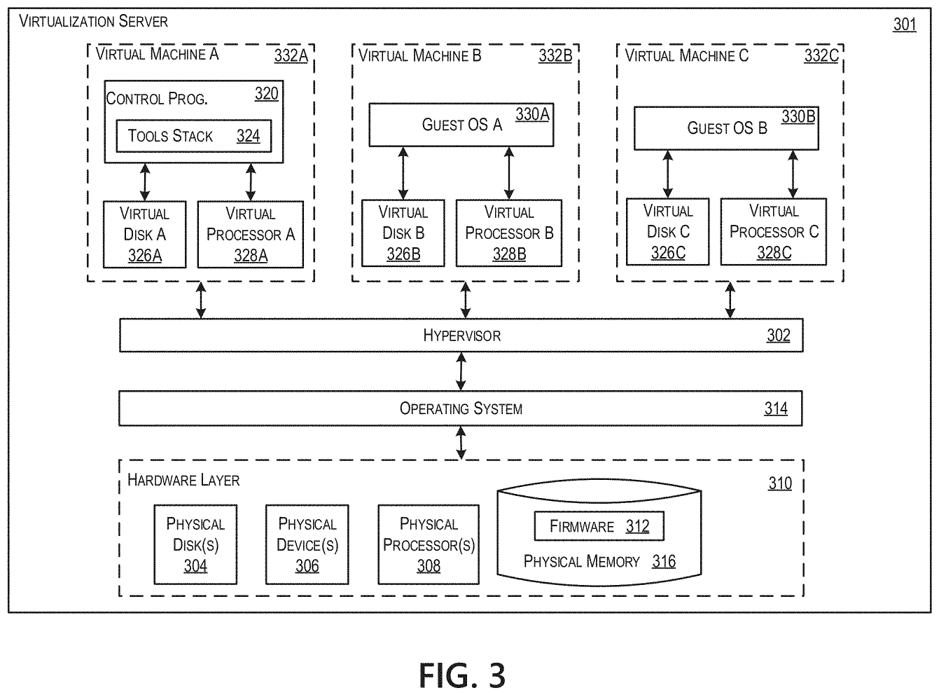

FIG. 3 shows a high-level architecture of an illustrative desktop virtualization system. As shown, the desktop virtualization system may be single-server or multi-server system, or cloud system, including at least one virtualization server 301 configured to provide virtual desktops and/or virtual applications to one or more client access devices 240. As used herein, a desktop refers to a graphical environment or space in which one or more applications may be hosted and/or executed. A desktop may include a graphical shell providing a user interface for an instance of an operating system in which local and/or remote applications can be integrated. Applications may include programs that execute after an instance of an operating system (and, optionally, also the desktop) has been loaded. Each instance of the operating system may be physical (e.g., one operating system per device) or virtual (e.g., many instances of an OS running on a single device). Each application may be executed on a local device, or executed on a remotely located device (e.g., remoted).

A computer device 301 may be configured as a virtualization server in a virtualization environment, for example, a single-server, multi-server, or cloud computing environment. Virtualization server 301 illustrated in FIG. 3 can be deployed as and/or implemented by one or more embodiments of server 206 illustrated in FIG. 2 or by other known computing devices. Included in virtualization server 301 is a hardware layer that can include one or more physical disks 304, one or more physical devices 306, one or more physical processors 308, and one or more physical memories 316. In some embodiments, firmware 312 can be stored within a memory element in physical memory 316 and can be executed by one or more of physical processors 308. Virtualization server 301 may further include an operating system 314 that may be stored in a memory element in physical memory 316 and executed by one or more of physical processors 308. Still further, a hypervisor 302 may be stored in a memory element in physical memory 316 and can be executed by one or more of physical processors 308.

Executing on one or more of physical processors 308 may be one or more virtual machines 332A-C (generally 332). Each virtual machine 332 may have a virtual disk 326A-C and a virtual processor 328A-C. In some embodiments, a first virtual machine 332A may execute, using a virtual processor 328A, a control program 320 that includes a tools stack 324. Control program 320 may be referred to as a control virtual machine, Dom0, Domain 0, or other virtual machine used for system administration and/or control. In some embodiments, one or more virtual machines 332B-C can execute, using a virtual processor 328B-C, a guest operating system 330A-B.

Virtualization server 301 may include a hardware layer 310 with one or more pieces of hardware that communicate with the virtualization server 301. In some embodiments, hardware layer 310 can include one or more physical disks 304, one or more physical devices 306, one or more physical processors 308, and one or more physical memory 316. Physical components 304, 306, 308, and 316 may include, for example, any of the components described above. Physical devices 306 may include, for example, a network interface card, a video card, a keyboard, a mouse, an input device, a monitor, a display device, speakers, an optical drive, a storage device, a universal serial bus connection, a printer, a scanner, a network element (e.g., router, firewall, network address translator, load balancer, virtual private network (VPN) gateway, Dynamic Host Configuration Protocol (DHCP) router, etc.), or any device connected to or communicating with virtualization server 301. Physical memory 316 in hardware layer 310 may include any type of memory. Physical memory 316 may store data, and in some embodiments may store one or more programs, or set of executable instructions. FIG. 3 illustrates an embodiment where firmware 312 is stored within physical memory 316 of virtualization server 301. Programs or executable instructions stored in physical memory 316 can be executed by one or more processors 308 of virtualization server 301.

Virtualization server 301 may also include a hypervisor 302. In some embodiments, hypervisor 302 may be a program executed by processors 308 on virtualization server 301 to create and manage any number of virtual machines 332. Hypervisor 302 may be referred to as a virtual machine monitor, or platform virtualization software. In some embodiments, hypervisor 302 can be any combination of executable instructions and hardware that monitors virtual machines executing on a computing machine. Hypervisor 302 may be Type 2 hypervisor, where the hypervisor executes within an operating system 314 executing on virtualization server 301. Virtual machines may then execute at a level above hypervisor 302. In some embodiments, the Type 2 hypervisor may execute within the context of a user's operating system such that the Type 2 hypervisor interacts with the user's operating system. In other embodiments, one or more virtualization servers 301 in a virtualization environment may instead include a Type 1 hypervisor (not shown). A Type 1 hypervisor may execute on virtualization server 301 by directly accessing the hardware and resources within the hardware layer 310. That is, while a Type 2 hypervisor 302 accesses system resources through a host operating system 314, as shown, a Type 1 hypervisor may directly access all system resources without host operating system 314. A Type 1 hypervisor may execute directly on one or more physical processors 308 of virtualization server 301, and may include program data stored in physical memory 316.

Hypervisor 302, in some embodiments, can provide virtual resources to operating systems 330 or control programs 320 executing on virtual machines 332 in any manner that simulates operating systems 330 or control programs 320 having direct access to system resources. System resources can include, but are not limited to, physical devices 306, physical disks 304, physical processors 308, physical memory 316, and any other component included in hardware layer 310 of virtualization server 301. Hypervisor 302 may be used to emulate virtual hardware, partition physical hardware, virtualize physical hardware, and/or execute virtual machines that provide access to computing environments. In still other embodiments, hypervisor 302 may control processor scheduling and memory partitioning for a virtual machine 332 executing on virtualization server 301. Hypervisor 302 may include those manufactured by VMWare, Inc., of Palo Alto, Calif.; HyperV, VirtualServer or virtual PC hypervisors provided by Microsoft, or others. In some embodiments, virtualization server 301 may execute a hypervisor 302 that creates a virtual machine platform on which guest operating systems may execute. In these embodiments, virtualization server 301 may be referred to as a host server. An example of such a virtualization server is the Citrix Hypervisor provided by Citrix Systems, Inc., of Fort Lauderdale, Fla.

Hypervisor 302 may create one or more virtual machines 332B-C (generally 332) in which guest operating systems 330 execute. In some embodiments, hypervisor 302 may load a virtual machine image to create a virtual machine 332. In other embodiments, hypervisor 302 may execute a guest operating system 330 within virtual machine 332. In still other embodiments, virtual machine 332 may execute guest operating system 330.

In addition to creating virtual machines 332, hypervisor 302 may control the execution of at least one virtual machine 332. In other embodiments, hypervisor 302 may present at least one virtual machine 332 with an abstraction of at least one hardware resource provided by virtualization server 301 (e.g., any hardware resource available within the hardware layer 310). In other embodiments, hypervisor 302 may control the manner in which virtual machines 332 access physical processors 308 available in virtualization server 301. Controlling access to physical processors 308 may include determining whether a virtual machine 332 should have access to a processor 308, and how physical processor capabilities are presented to virtual machine 332.

As shown in FIG. 3, virtualization server 301 may host or execute one or more virtual machines 332. A virtual machine 332 is a set of executable instructions that, when executed by a processor 308, may imitate the operation of a physical computer such that virtual machine 332 can execute programs and processes much like a physical computing device. While FIG. 3 illustrates an embodiment where a virtualization server 301 hosts three virtual machines 332, in other embodiments virtualization server 301 can host any number of virtual machines 332. Hypervisor 302, in some embodiments, may provide each virtual machine 332 with a unique virtual view of the physical hardware, memory, processor, and other system resources available to that virtual machine 332. In some embodiments, the unique virtual view can be based on one or more of virtual machine permissions, application of a policy engine to one or more virtual machine identifiers, a user accessing a virtual machine, the applications executing on a virtual machine, networks accessed by a virtual machine, or any other desired criteria. For instance, hypervisor 302 may create one or more unsecure virtual machines 332 and one or more secure virtual machines 332. Unsecure virtual machines 332 may be prevented from accessing resources, hardware, memory locations, and programs that secure virtual machines 332 may be permitted to access. In other embodiments, hypervisor 302 may provide each virtual machine 332 with a substantially similar virtual view of the physical hardware, memory, processor, and other system resources available to virtual machines 332.

Each virtual machine 332 may include a virtual disk 326A-C (generally 326) and a virtual processor 328A-C (generally 328.) Virtual disk 326, in some embodiments, is a virtualized view of one or more physical disks 304 of virtualization server 301, or a portion of one or more physical disks 304 of virtualization server 301. The virtualized view of physical disks 304 can be generated, provided, and managed by hypervisor 302. In some embodiments, hypervisor 302 provides each virtual machine 332 with a unique view of the physical disks 304. Thus, in these embodiments, particular virtual disk 326 included in each virtual machine 332 can be unique when compared with other virtual disks 326.

A virtual processor 328 can be a virtualized view of one or more physical processors 308 of virtualization server 301. In some embodiments, the virtualized view of physical processors 308 can be generated, provided, and managed by hypervisor 302. In some embodiments, virtual processor 328 has substantially all of the same characteristics of at least one physical processor 308. In other embodiments, virtual processor 308 provides a modified view of physical processors 308 such that at least some of the characteristics of virtual processor 328 are different than the characteristics of the corresponding physical processor 308.

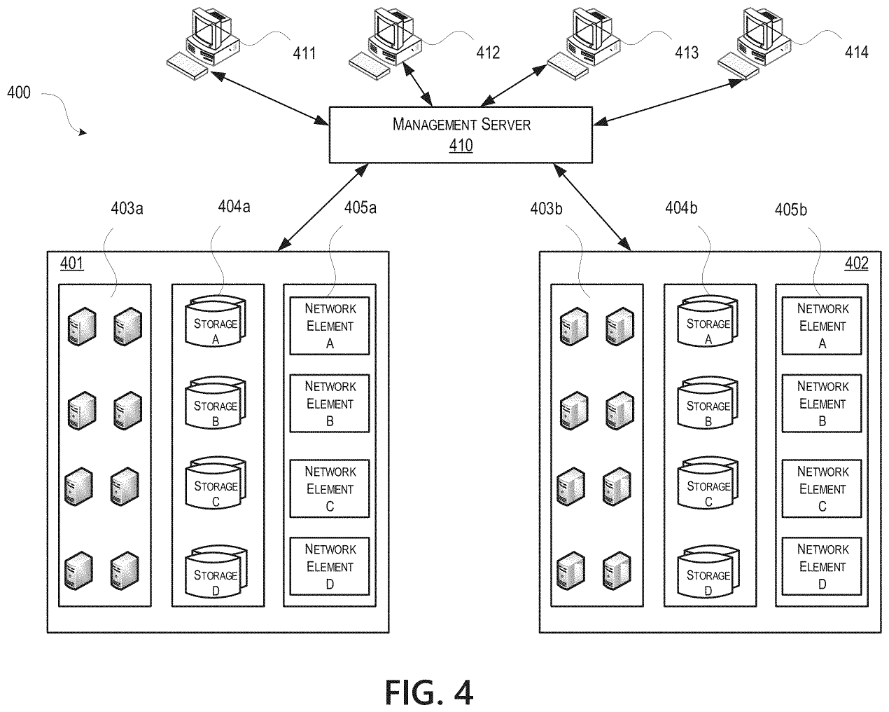

With further reference to FIG. 4, some aspects described herein may be implemented in a cloud-based environment. FIG. 4 illustrates an example of a cloud computing environment (or cloud system) 400. As seen in FIG. 4, client computers 411-414 may communicate with a cloud management server 410 to access the computing resources (e.g., host servers 403a-403b (generally referred herein as “host servers 403”), storage resources 404a-404b (generally referred herein as “storage resources 404”), and network elements 405a-405b (generally referred herein as “network resources 405”)) of the cloud system.

Management server 410 may be implemented on one or more physical servers. The management server 410 may run, for example, Citrix Cloud by Citrix Systems, Inc. of Ft. Lauderdale, Fla., or OPENSTACK, among others. Management server 410 may manage various computing resources, including cloud hardware and software resources, for example, host computers 403, data storage devices 404, and networking devices 405. The cloud hardware and software resources may include private and/or public components. For example, a cloud may be configured as a private cloud to be used by one or more particular customers or client computers 411-414 and/or over a private network. In other embodiments, public clouds or hybrid public-private clouds may be used by other customers over an open or hybrid networks.

Management server 410 may be configured to provide user interfaces through which cloud operators and cloud customers may interact with the cloud system 400. For example, management server 410 may provide a set of application programming interfaces (APIs) and/or one or more cloud operator console applications (e.g., web-based or standalone applications) with user interfaces to allow cloud operators to manage the cloud resources, configure the virtualization layer, manage customer accounts, and perform other cloud administration tasks. Management server 410 also may include a set of APIs and/or one or more customer console applications with user interfaces configured to receive cloud computing requests from end users via client computers 411-414, for example, requests to create, modify, or destroy virtual machines within the cloud. Client computers 411-414 may connect to management server 410 via the Internet or some other communication network, and may request access to one or more of the computing resources managed by management server 410. In response to client requests, management server 410 may include a resource manager configured to select and provision physical resources in the hardware layer of the cloud system based on the client requests. For example, management server 410 and additional components of the cloud system may be configured to provision, create, and manage virtual machines and their operating environments (e.g., hypervisors, storage resources, services offered by the network elements, etc.) for customers at client computers 411-414, over a network (e.g., the Internet), providing customers with computational resources, data storage services, networking capabilities, and computer platform and application support. Cloud systems also may be configured to provide various specific services, including security systems, development environments, user interfaces, and the like.

Certain clients 411-414 may be related, for example, to different client computers creating virtual machines on behalf of the same end user, or different users affiliated with the same company or organization. In other examples, certain clients 411-414 may be unrelated, such as users affiliated with different companies or organizations. For unrelated clients, information on the virtual machines or storage of any one user may be hidden from other users.

Referring now to the physical hardware layer of a cloud computing environment, availability zones 401-402 (or zones) may refer to a collocated set of physical computing resources. Zones may be geographically separated from other zones in the overall cloud of computing resources. For example, zone 401 may be a first cloud datacenter located in California, and zone 402 may be a second cloud datacenter located in Florida. Management server 410 may be located at one of the availability zones, or at a separate location. Each zone may include an internal network that interfaces with devices that are outside of the zone, such as the management server 410, through a gateway. End users of the cloud (e.g., clients 411-414) might or might not be aware of the distinctions between zones. For example, an end user may request the creation of a virtual machine having a specified amount of memory, processing power, and network capabilities. Management server 410 may respond to the user's request and may allocate the resources to create the virtual machine without the user knowing whether the virtual machine was created using resources from zone 401 or zone 402. In other examples, the cloud system may allow end users to request that virtual machines (or other cloud resources) are allocated in a specific zone or on specific resources 403-405 within a zone.

In this example, each zone 401-402 may include an arrangement of various physical hardware components (or computing resources) 403-405, for example, physical hosting resources (or processing resources), physical network resources, physical storage resources, switches, and additional hardware resources that may be used to provide cloud computing services to customers. The physical hosting resources in a cloud zone 401-402 may include one or more computer servers 403, such as the virtualization servers 301 described above, which may be configured to create and host virtual machine instances. The physical network resources in a cloud zone 401 or 402 may include one or more network elements 405 (e.g., network service providers) comprising hardware and/or software configured to provide a network service to cloud customers, such as firewalls, network address translators, load balancers, virtual private network (VPN) gateways, Dynamic Host Configuration Protocol (DHCP) routers, and the like. The storage resources in the cloud zone 401-402 may include storage disks (e.g., solid state drives (SSDs), magnetic hard disks, etc.) and other storage devices.

The example cloud computing environment shown in FIG. 4 also may include a virtualization layer (e.g., as shown in FIGS. 1-3) with additional hardware and/or software resources configured to create and manage virtual machines and provide other services to customers using the physical resources in the cloud. The virtualization layer may include hypervisors, as described above in FIG. 3, along with other components to provide network virtualizations, storage virtualizations, etc. The virtualization layer may be as a separate layer from the physical resource layer, or may share some or all of the same hardware and/or software resources with the physical resource layer. For example, the virtualization layer may include a hypervisor installed in each of the virtualization servers 403 with the physical computing resources. Known cloud systems may alternatively be used, e.g., WINDOWS AZURE (Microsoft Corporation of Redmond, Wash.), AMAZON EC2 (Amazon.com Inc. of Seattle, Wash.), IBM BLUE CLOUD (IBM Corporation of Armonk, N.Y.), or others.

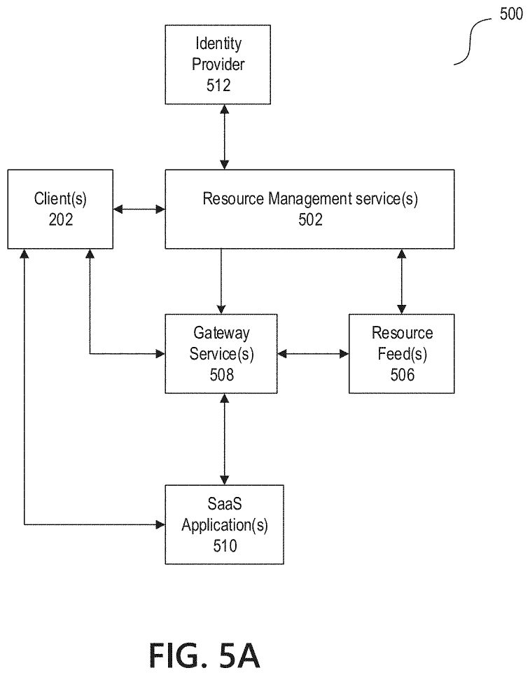

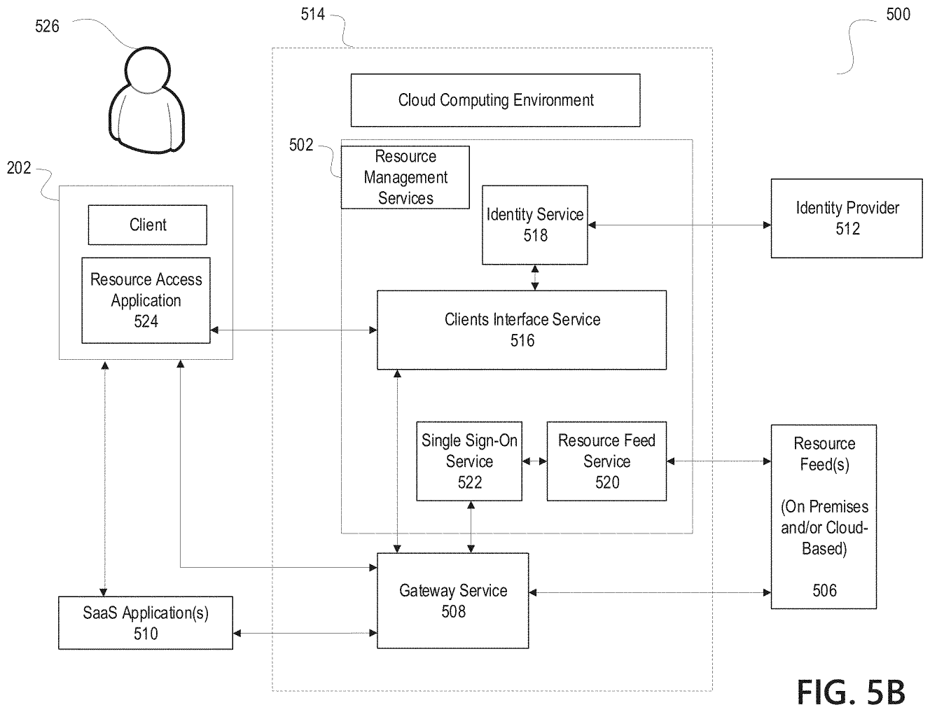

FIG. 5A is a block diagram of an example system 500 in which one or more resource management services 502 may manage and streamline access by one or more clients 202 to one or more resource feeds 506 (via one or more gateway services 508) and/or one or more software-as-a-service (SaaS) applications 510. In particular, resource management service(s) 502 may employ an identity provider 512 to authenticate the identity of a user of a client 202 and, following authentication, identify one of more resources the user is authorized to access. In response to the user selecting one of the identified resources, resource management service(s) 502 may send appropriate access credentials to requesting client 202, and client 202 may then use those credentials to access the selected resource. For the resource feed(s) 506, client 202 may use the supplied credentials to access the selected resource via a gateway service 508. For SaaS application(s) 510, client 202 may use the credentials to access the selected application directly.

The client(s) 202 may be any type of computing devices capable of accessing the resource feed(s) 506 and/or the SaaS application(s) 510, and may, for example, include a variety of desktop or laptop computers, smartphones, tablets, etc. The resource feed(s) 506 may include any of numerous resource types and may be provided from any of numerous locations. In some embodiments, for example, the resource feed(s) 506 may include one or more systems or services for providing virtual applications and/or desktops to the client(s) 202, one or more file repositories and/or file sharing systems, one or more secure browser services, one or more access control services for the SaaS applications 510, one or more management services for local applications on the client(s) 202, one or more internet enabled devices or sensors, etc. Each of the resource management service(s) 502, the resource feed(s) 506, the gateway service(s) 508, the SaaS application(s) 510, and the identity provider 512 may be located within an on-premises data center of an organization for which the system 500 is deployed, within one or more cloud computing environments, or elsewhere.

FIG. 5B is a block diagram showing an example implementation of the system 500 shown in FIG. 5A in which various resource management services 502 as well as a gateway service 508 are located within a cloud computing environment 514. The cloud computing environment may, for example, include Microsoft Azure Cloud, Amazon Web Services, Google Cloud, or IBM Cloud.

For any of illustrated components (other than client 202) that are not based within cloud computing environment 514, cloud connectors (not shown in FIG. 5B) may be used to interface those components with cloud computing environment 514. Such cloud connectors may, for example, run on Windows Server instances hosted in resource locations and may create a reverse proxy to route traffic between the site(s) and cloud computing environment 514. In the illustrated example, the cloud-based resource management services 502 include a client interface service 516, an identity service 518, a resource feed service 520, and a single sign-on service 522. As shown, in some embodiments, client 202 may use a resource access application/platform 524 to communicate with client interface service 516 as well as to present a user interface on the client 202 that a user 526 can operate to access resource feed(s) 506 and/or SaaS application(s) 510. Resource access application 524 may either be installed on client 202, or may be executed by client interface service 516 (or elsewhere in system 500) and accessed using a web browser (not shown in FIG. 5B) on client 202.

As explained in more detail below, in some embodiments, resource access application 524 and associated components may provide user 526 with a personalized, all-in-one interface, enabling instant and seamless access to all the user's SaaS and web applications, files, virtual Windows applications, virtual Linux applications, desktops, mobile applications, Citrix Virtual Apps and Desktops™, local applications, and other data.

When resource access application 524 is launched or otherwise accessed by user 526, client interface service 516 may send a sign-on request to identity service 518. In some embodiments, identity provider 512 may be located on the premises of the organization for which system 500 is deployed. Identity provider 512 may, for example, correspond to an on-premises Windows Active Directory. In such embodiments, identity provider 512 may be connected to cloud-based identity service 518 using a cloud connector (not shown in FIG. 5B), as described above. Upon receiving a sign-on request, identity service 518 may cause the resource access application 524 (via client interface service 516) to prompt user 526 for the user's authentication credentials (e.g., user-name and password). Upon receiving the user's authentication credentials, client interface service 516 may pass the credentials along to identity service 518, and identity service 518 may, in turn, forward them to identity provider 512 for authentication, for example, by comparing them against an Active Directory domain. Once identity service 518 receives confirmation from identity provider 512 that the user's identity has been properly authenticated, client interface service 516 may send a request to resource feed service 520 for a list of subscribed resources for user 526.

In other embodiments (not illustrated in FIG. 5B), identity provider 512 may be a cloud-based identity service, such as a Microsoft Azure Active Directory. In such embodiments, upon receiving a sign-on request from client interface service 516, identity service 518 may, via client interface service 516, cause client 202 to be redirected to the cloud-based identity service to complete an authentication process. The cloud-based identity service may then cause client 202 to prompt user 526 to enter the user's authentication credentials. Upon determining the user's identity has been properly authenticated, the cloud-based identity service may send a message to resource access application 524 indicating the authentication attempt was successful, and resource access application 524 may then inform the client interface service 516 of the successfully authentication. Once the identity service 518 receives confirmation from client interface service 516 that the user's identity has been properly authenticated, client interface service 516 may send a request to resource feed service 520 for a list of subscribed resources for user 526.

For each configured resource feed, resource feed service 520 may request an identity token from the single sign-on service 522. Resource feed service 520 may then pass the feed-specific identity tokens it receives to the points of authentication for respective resource feeds 506. Each resource feed 506 may then respond with a list of resources configured for the respective identity. Resource feed service 520 may then aggregate all items from the different feeds and forward them to client interface service 516, which may cause resource access application 524 to present a list of available resources on a user interface of client 202. The list of available resources may, for example, be presented on the user interface of client 202 as a set of selectable icons or other elements corresponding to accessible resources. The resources so identified may, for example, include one or more virtual applications and/or desktops (e.g., Citrix Virtual Apps and Desktops™, VMware Horizon, Microsoft RDS, etc.), one or more file repositories and/or file sharing systems (e.g., ShareFile®, one or more secure browsers, one or more internet enabled devices or sensors, one or more local applications installed on client 202, and/or one or more SaaS applications 510 to which user 526 has subscribed). The lists of local applications and SaaS applications 510 may, for example, be supplied by resource feeds 506 for respective services that manage which such applications are to be made available to user 526 via resource access application 524. Examples of SaaS applications 510 that may be managed and accessed as described herein include Microsoft Office 365 applications, SAP SaaS applications, Workday applications, etc.

For resources other than local applications and SaaS application(s) 510, upon user 526 selecting one of the listed available resources, resource access application 524 may cause client interface service 516 to forward a request for the specified resource to resource feed service 520. In response to receiving such a request, resource feed service 520 may request an identity token for the corresponding feed from the single sign-on service 522. The resource feed service 520 may then pass the identity token received from single sign-on service 522 to client interface service 516 where a launch ticket for the resource may be generated and sent to resource access application 524. Upon receiving the launch ticket, resource access application 524 may initiate a secure session to gateway service 508 and present the launch ticket. When gateway service 508 is presented with the launch ticket, it may initiate a secure session to the appropriate resource feed and present the identity token to that feed to seamlessly authenticate user 526. Once the session initializes, client 202 may proceed to access the selected resource.

When user 526 selects a local application, resource access application 524 may cause the selected local application to launch on client 202. When user 526 selects a SaaS application 510, resource access application 524 may cause client interface service 516 request a one-time uniform resource locator (URL) from gateway service 508 as well a preferred browser for use in accessing SaaS application 510. After gateway service 508 returns the one-time URL and identifies the preferred browser, client interface service 516 may pass that information along to resource access application 524. Client 202 may then launch the identified browser and initiate a connection to the gateway service 508. Gateway service 508 may then request an assertion from single sign-on service 522. Upon receiving the assertion, gateway service 508 may cause the identified browser on client 202 to be redirected to the logon page for identified SaaS application 510 and present the assertion. The SaaS may then contact gateway service 508 to validate the assertion and authenticate user 526. Once the user has been authenticated, communication may occur directly between the identified browser and selected SaaS application 510, thus allowing user 526 to use client 202 to access selected SaaS application 510.

In some embodiments, the preferred browser identified by the gateway service 508 may be a specialized browser embedded in resource access application 524 (when the resource application is installed on client 202) or provided by one of resource feeds 506 (when resource application 524 is located remotely), e.g., via a secure browser service. In such embodiments, SaaS applications 510 may incorporate enhanced security policies to enforce one or more restrictions on the embedded browser. Examples of such policies include (1) requiring use of the specialized browser and disabling use of other local browsers, (2) restricting clipboard access, e.g., by disabling cut/copy/paste operations between the application and the clipboard, (3) restricting printing, e.g., by disabling the ability to print from within the browser, (3) restricting navigation, e.g., by disabling the next and/or back browser buttons, (4) restricting downloads, e.g., by disabling the ability to download from within the SaaS application, and (5) displaying watermarks, e.g., by overlaying a screen-based watermark showing the username and IP address associated with client 202 such that the watermark will appear as displayed on the screen if the user tries to print or take a screenshot. Further, in some embodiments, when a user selects a hyperlink within a SaaS application, the specialized browser may send the URL for the link to an access control service (e.g., implemented as one of resource feed(s) 506) for assessment of its security risk by a web filtering service. For approved URLs, the specialized browser may be permitted to access the link. For suspicious links, however, the web filtering service may have client interface service 516 send the link to a secure browser service, which may start a new virtual browser session with client 202, and thus allow the user to access the potentially harmful linked content in a safe environment.

In some embodiments, in addition to or in lieu of providing user 526 with a list of resources that are available to be accessed individually, as described above, user 526 may instead be permitted to choose to access a streamlined feed of event notifications and/or available actions that may be taken with respect to events that are automatically detected with respect to one or more of the resources. This streamlined resource activity feed, which may be customized for each user 526, may allow users to monitor important activity involving all of their resources—SaaS applications, web applications, Windows applications, Linux applications, desktops, file repositories and/or file sharing systems, and other data through a single interface, without needing to switch context from one resource to another. Further, event notifications in a resource activity feed may be accompanied by a discrete set of user-interface elements, e.g., “approve,” “deny,” and “see more detail” buttons, allowing a user to take one or more simple actions with respect to each event right within the user's feed. In some embodiments, such a streamlined, intelligent resource activity feed may be enabled by one or more micro-applications, or “microapps,” that can interface with underlying associated resources using APIs or the like. The responsive actions may be user-initiated activities that are taken within the microapps and that provide inputs to the underlying applications through the API or other interface. The actions a user performs within the microapp may, for example, be designed to address specific common problems and use cases quickly and easily, adding to increased user productivity (e.g., request personal time off, submit a help desk ticket, etc.). In some embodiments, notifications from such event-driven microapps may additionally or alternatively be pushed to client 202 to notify user 526 of something that requires the user's attention (e.g., approval of an expense report, new course available for registration, etc.).

Transparent Application Overlay

Aspects of the present disclosure describe transparent application overlays. In some examples, aspects of the present disclosure describe providing a transparent application window or overlay in relation to (e.g., on top of or otherwise overlaid) another application window (e.g., a currently running application window) on a user interface of a computing device. For example, some aspects of the present disclosure describe that a transparent application window or overlay and another application window may be displayed on the user interface and the location of the overlay may be determined based on the content of the transparent application window and/or the content of another application window. For example, the overlay may be positionable on top of another application window, and the location of the overlay may be determined to minimize the overlap between the content of the transparent application window and the content of another application window. As another example, the content within the overlay may be rearranged based on the content of the transparent application window and/or the content of another application window, while the size of the overlay may remain the same. In this way, smart pass-through inputs may be achieved. Because the overlap between the content of the transparent application window and the content of another application window is minimized, a user device may determine an intended application (e.g., one of a first application associated with the overlay or a second application associated with the different application window) to perform an operation in response to a user input on the overlay. For example, based on the location of the user input (e.g., a user clicks on a content item on the overlay), a user device may determine that the user input intends to cause a second application associated with the different application window to perform an operation, the user device may pass through or otherwise transmit the user input from the transparent application window to the different application window and cause the second application to perform an operation based on the user input. As another example, some aspects of the present disclosure describe that user inputs (e.g., clicks) on the transparent application window may pass through or otherwise be transmitted from the transparent application window to a different window based on the user selection of a click-through status indicator on the user interface.

Additionally, aspects of the present disclosure describe automatically causing (e.g., prompting, instructing) output of a transparent application window based on a selection of a content item of another application window. For example, based on one or more user preferences and/or user input, an application window may be generated in a transparent and/or nonoverlapping fashion with the content of another application (e.g., a currently running application window). For example, if a first application receives a user input to output a second application (e.g., a user selection of a link to the second application), a transparent window of the second application may be generated and output on top of the first application.

As illustrated in greater detail below, some aspects of the disclosure may provide technical benefits that are not provided by conventional systems. The blending of a transparent window and one or more other windows (e.g., existing windows) within a single display may provide an improved user experience. For example, one or more aspects of the disclosure may determine (e.g., automatically determine) and output one or more transparent application windows at appropriate locations of a user interface without any intervention of users. In this way, users may be able to easily view the content of multiple windows without performing any actions such as switching application windows, adjusting (e.g., minimizing) an application window, and/or moving an application window. Because the overlap between the content of the transparent application window and the content of another application window may cause confusion as to the selection of the content, some aspects of the disclosure describe techniques that minimize such overlap, so that a user can easily distinguish the content of the transparent application window from the content of another application window. In this way, smart pass-through inputs may be achieved, as described above. Additionally, visual cues may be added for the selection of content on the transparent application window and/or another application window. Various other technical benefits may be achieved as well.

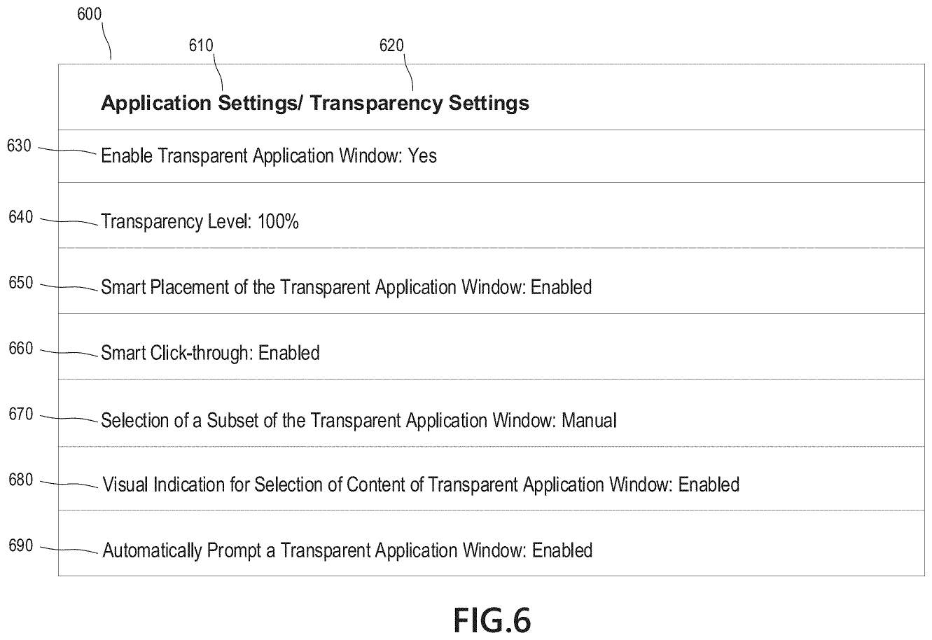

FIG. 6 depicts an example user interface for application transparency settings that may be used in accordance with one or more illustrative aspects described herein. In FIG. 6, one or more lists of selectable options may be arranged vertically on a user interface. Other types of layouts of the options, such as horizontally arranging the options, may also or alternatively be presented on the user interface. The user interface may have multiple levels of hierarchies and the user interface shown in FIG. 6 is an example level of hierarchies. Additional levels (e.g., lower levels) of the user interface may be available for additional options related to the application transparency settings. The user interface may have different appearances from those shown in the figures herein, depending upon the implementations thereof. Options that may be provided in a menu or other user interface are not limited to the options shown in FIG. 6, and other options may also or alternatively be displayed on the user interface presented herein. The user interface may be a menu-based system that provides a variety of options associated with the transparency features for user selection. The user interface may be part of one or more configuration/set-up interface for applications that are downloaded and/or installed.

In FIG. 6, a user interface 600 may comprise an option 610 for application settings. The option 610 may be selected to set, modify, and/or otherwise configure settings related to an application (or a group of applications). The application may be a computing software configured to perform specific tasks and may be, for example, a workspace application or a remote desktop application. The workspace application may be a software platform that allows users to remotely access and use virtual resources (e.g., a virtual desktop, a virtual application). Some details of an example of a workspace application (e.g., the resource access application 524) have been described in connection with FIGS. 5A and 5B. The application may also comprise virtual applications and web-based applications. The option 610 may comprise settings that control and/or otherwise relate to the transparency of the application, that control and/or otherwise relate to the texts displayed within the application, and/or that control and/or otherwise relate to a size of the application window.

The user interface 600 may comprise an option 620 for transparency settings. The option 620 may comprise options that can be selected to set, modify, and/or otherwise configure settings related to the transparency of an application window of the application executable on a computing device. An overlay may be generated on top of a window of another application (e.g., a foreground or active application, a window that the user is currently using, a web page, file explorer, file folder, a document, a text) on a user interface of the computing device. The overlay may be an overlapped portion on a user interface (e.g., screen) between the window of the another application and the transparent application window. The overlay may be displayed in a transparent fashion or semi-transparent fashion so that the another application appears visible upon display of the overlay thereon.

The user interface 600 may comprise an option 630 that a user may select (e.g., by highlighting with a cursor and pressing a “select,” “enter,” or “yes” button) to enable or disable a transparent application window feature. If the transparent application window feature is disabled, other transparency setting options might not be available to be configured. If the transparent application window feature is enabled, then the application window may be rendered as a transparent application window when it overlays at least a portion of another application window. A user may further set, modify, and/or otherwise configure if only the overlaid portion of the application window is transparent or if the entire application window is transparent.

The user interface 600 may comprise an option 640 that a user may select to set, modify, and/or otherwise configure a level of transparency of the application window. The user may select the option 640 to go to one or more menus (e.g., drop-down menus) to set a transparency level of the application window. The transparency level of the application window may comprise a default level, an opaque level, a translucent level, a semitransparent level, and/or a transparent level. Additionally or alternatively, the transparency level of the application window may comprise a numerical level (e.g., 0%, 50%, 100%) of the transparency of the application window.

The user interface 600 may comprise an option 650 that a user may select to set, modify, and/or otherwise configure the location of the transparent application window. For example, the user may enable smart placement of the transparent application window. As further described below, the smart placement of the transparent application may allow a user device to determine the most suitable location for placing the transparent application window. The smart placement of the transparent application may enable the visible content of the transparent application to be displayed in a nonoverlapping fashion with the content of another application window and enable use of multiple applications with one window. The user device may determine the location of the transparent application window on the right side of another application window, on the left side of another application window, on the upper side of another application window, on the lower side of another application window, or on any other specific area in relation to another application window. The transparent application window may be a background window (e.g., a non-active window, a window that the user is not currently using).

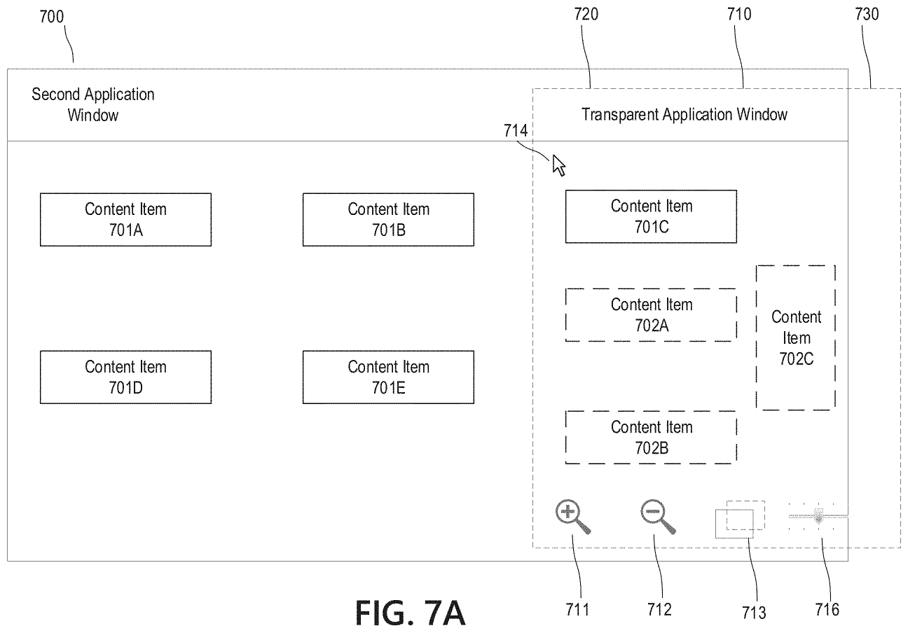

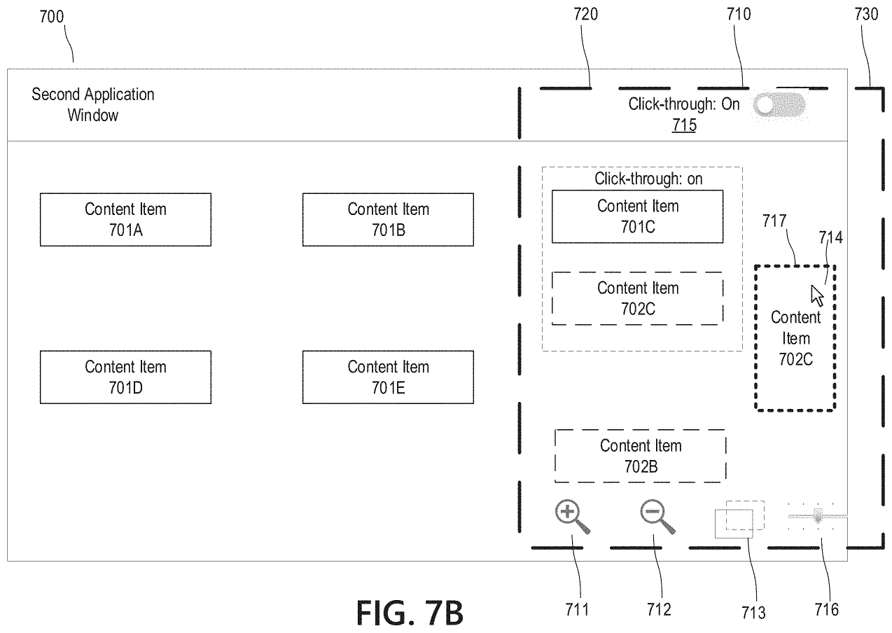

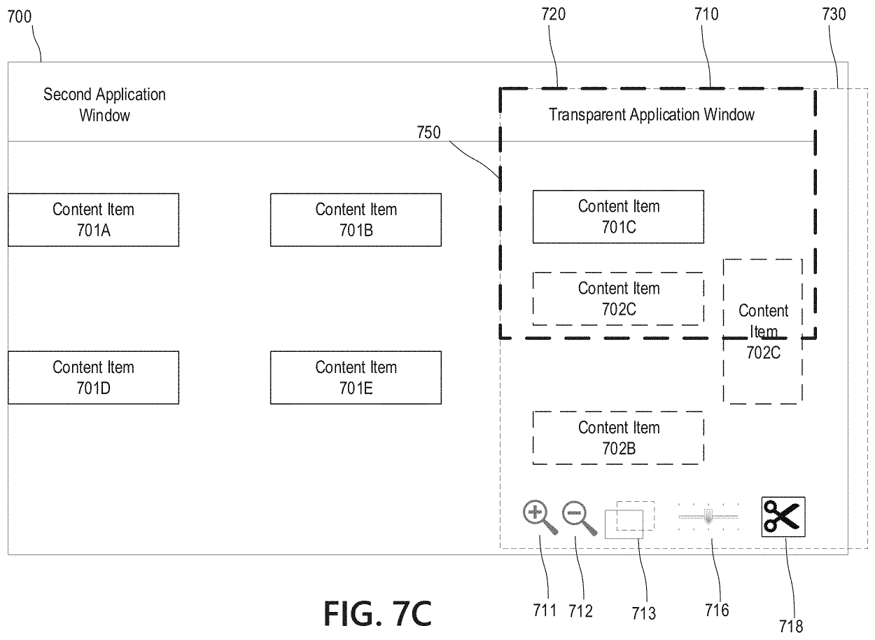

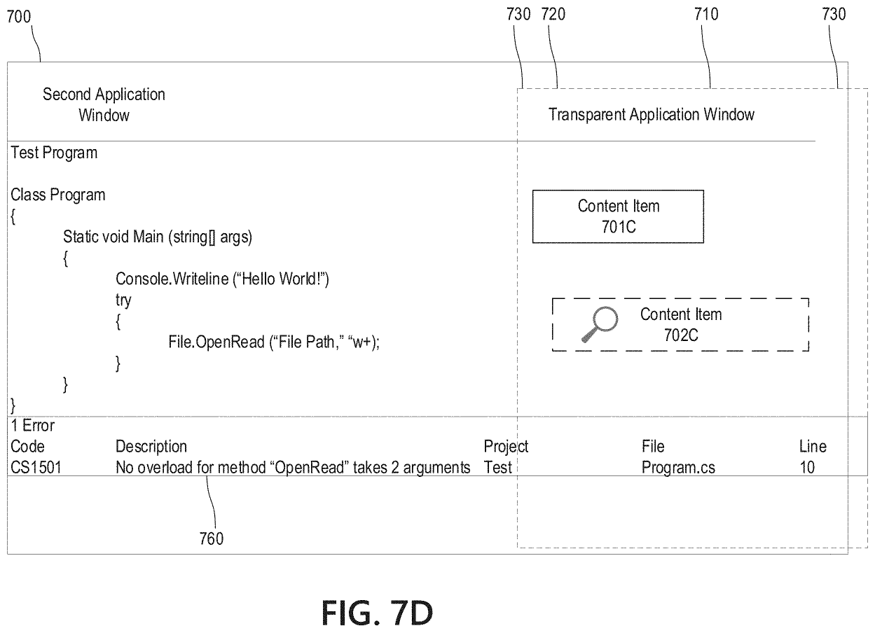

The location of the transparent application window may be determined automatically and/or dynamically. The automatic determination of the location of the transparent application window may be based on the content of another application window on the user interface and/or the content of the transparent application window. The content of an application may comprise one or more actionable items (e.g., a link, a button, an editable item, an input field, a selectable item (e.g., checkbox, radio button, drop down menu), a navigation or other control feature) and/or functionalities within the application window. For example, the location of the transparent application window may be determined such that the content of the transparent application window does not overlap with the content of the foreground window (e.g., a window that the user is currently using, an active window) on the user interface. The transparent application window may be the background window on the user interface. If the content of the foreground window changes over time, the location of the transparent application window may be dynamically determined based on the changes. For example, the content of the foreground window may be determined periodically and a corresponding location of the transparent application window may be determined accordingly. Additional details of the option 650 are described in connection with FIGS. 7A-7D.

The user interface 600 may comprise an option 660 that a user may select to set, modify, and/or otherwise configure the smart click-through of the transparent application window. For example, a user may enable the smart click-through of the transparent application window, which causes a user device to automatically determine the appropriate application to perform an operation from applications displayed within either the window beneath the overlay or within the transparent overlay in response to receiving a user input on the overlay. The determination of the appropriate application may be based on the selected content on the overlay. For example, if a user input is received on the overlay, the received user input may be intended for an element (e.g., a content item) of the content of another application displayed within the window beneath and visible through the overlay. The intention of the user input may be determined based on the location of the user input on the overlay and based on whether the overlay or another application window includes an element corresponding to the location of the user input. A user device may determine the element of the content of the another application corresponding to the received user input, and provide an instruction or command to the another application. The instruction may cause the another application to replicate an input received on the determined element of the content of the another application to initiate the another application to perform an action. In some examples, if the smart placement of the transparent application feature is enabled, the option 660 may be enabled under the default setting.

A computing device might not need to configure or predetermine an overlay operation mode for receiving user inputs on the overlay, if, for example, the smart placement of the transparent application feature is enabled. The transparent application window may overlay at least a portion of another application window (e.g., a foreground window) executable on a computing device. Based on the smart placement of the transparent application, the computing device may determine the operations of the overlay in response to user inputs received thereon. For example, because the content of the transparent application window does not overlap with the content of another window, a user device may determine which application to perform an operation in response to receipt of input on the overlay. The operation may be associated with a content item of a window present beneath a portion of the overlay on which the input was received. For example, if a first application is a remote desktop application (e.g., provided by the virtualization server 301) and the application of the overlay is an email application, a user input (e.g., a click) on a content item (e.g., input field) of the email application may cause an action to be performed on the email application (e.g., cause a cursor to appear on the email application and a user may start typing on the email application), even if the email application overlays on the remote desktop application. In this case, a user device may determine that receipt of input on the overlay does not cause the remote desktop application to perform an operation based on the location of the user input on the user interface (e.g., on a content item of the email application). But if a user input (e.g., a click) is on a content item of the remote desktop application, the remote desktop application may perform an operation (e.g., select a microapp within the workspace application, select a notification, view an activity feed) based on the user input because the content item of the remote desktop application does not overlap with any content item of the email application, even if the email application overlays on the remote desktop application.

The user interface 600 may comprise an option 670 that a user may select to set, modify, and/or otherwise configure the selection of a subset (e.g., a portion) of the transparent application window. The subset of the transparent application window may comprise a live subset of the transparent application window. For example, the live subset of the transparent application window may be a portion of the actual transparent application window, similar to a resized transparent application window. The live subset of the transparent application window may reflect the changes contained in the original transparent application window and might not be just a screenshot of a part of the transparent application window.

A user may configure the selection of a subset of the transparent application window to be manual and/automatic. The manual selection of a subset of the transparent application window may allow the user to select (e.g., capture) a subset of the transparent application window to be output. For example, the user may be interested in viewing only a portion of the transparent application window, and may use a tool (e.g., an application, a microapp) to select (e.g., drag a cursor around the area the user would like to capture) one or more areas of the transparent application window to be output in a transparent fashion.

The automatic selection of a subset of the transparent application window may allow a user device to determine a subset of the transparent application window to be output in a transparent fashion without any user selection of the subset. For example, a user device may store information associated with a plurality of applications for particular users. The information may indicate that some features and/or content of certain applications are not important. For example, if a user conducts a search through a web browser, a user might not be interested in the last couple of search results shown in the web browser. Instead, a user may be interested in the first couple of search results shown in the web browser. The user device may determine, for one or more of the plurality of applications, that some content of the application should not be output if the application is output in a transparent fashion. For example, if the application is a web browser, the user device may determine that users may be interested in viewing only the top half of the content shown in the web browser, thus the user device may output only the top half of the content of the web browser if the web browser is determined to be output in a transparent fashion. Additional details of the option 670 are described, for example, in connection with FIG. 7C.

The user interface 600 may comprise an option 680 to set, modify, and/or otherwise configure visual indications for selection of content of transparent application window. If the visual indication feature is not enabled, no visual indication may be output for selection of content of transparent application window (or overlay). If the visual indication feature is enabled, the user may set or otherwise determine a visual indicator to highlight a user selection of a content item (e.g., a link, a document, an icon, an input field, a group of texts, a widget) of transparent application window (or overlay), to more clearly show which content item the user intends to select. The visual indicator may comprise images, texts, pointers, shapes, and/or other types of indicators to highlight or otherwise emphasize the content item that the user intends to select, so that the user knows which application will perform a corresponding action based on the user input.

The user may determine (e.g., customize) the type and/or color of the visual indicator. For example, the user may determine the visual indicator to be a green bounding box that surrounds the content item that the user intends to select. The visual indicator may be output before the user actually clicks on or otherwise selects the item. For example, the visual indicator may be displayed based on predetermined events (e.g., a mouse hovers over an actionable content item). A user device may configure or otherwise define the events (e.g., mouseover) that trigger the visual indicator using, for example, JavaScript or Cascading Style Sheets. Additional details of the option 680 are described, for example, in connection with FIG. 7B.

The user interface 600 may comprise an option 690 to set, modify, and/or otherwise configure automatic output of a transparent application window. If the automatic output of a transparent application window feature is enabled, a user may set or otherwise configure which applications should be output in a transparent fashion based on user inputs. Additionally, a user may configure that certain user inputs may automatically prompt a transparent application window. A user device may store information comprising user preferences for output of a transparent application window when the user is using a different application window (e.g., a foreground window). For example, the user device may store information that indicates if a user selects certain content items (e.g., a link to a website) on a first application, a second application (e.g., a web browser) will be output in a transparent application window or overlay. Additional details of the option 690 are described, for example, in connection with FIG. 7D.

FIGS. 7A-7D depict example transparent application windows or overlays that may be used in accordance with one or more illustrative aspects described herein. In FIG. 7A, a transparent application window 710 (as indicated by the dotted lines) of a first application may overlay a second application window 700 (e.g., a foreground application window) of a second application (e.g., application visible beneath but not part of the overlay) on a user interface of a computing device (e.g., the terminals 240). The second application window 700 includes an application that a user is currently using or otherwise displayed. An overlay 720 (e.g., a portion of the transparent application window 710 that overlaps with the second application window 700) may be output on top of a portion of the second application window 700. A portion of the first application window 730 might not overlay the second application window 700 or any other application window, and that portion of the first application window 730 might not be transparent. The overlay 720 may be transparent (e.g., a user is able to see through or otherwise recognize content displayed beneath the overlay 720) so that the overlapped portion of the second application window 700 and the transparent application window 710 are both visible to a user. Transparent may also refer to a visually displayed transparency effect, without any physical transparency of the monitor or display on which the user interface is displayed. That is, colors of multiple windows or objects may be blended together to give the appearance that a first window or object on a display screen is transparent or translucent, such that the user can at least partially view second content “behind” the first window or object. The transparent application window 710 may provide a number of shortcuts and/or links for different functionalities such as a home page, actions, notifications, activity feeds, desktops, and/or files. A user may initiate or otherwise activate the shortcuts and/or links provided by the transparent application window 710. The transparent application window 710 may also comprise a zoom-in icon 711 and a zoom-out icon 712 so that a user may select one of the icons 711 and 712 to adjust a size of the transparent application window 710. In other examples, the size of the overlay can be adjusted by dragging and dropping boundary segment of the window to a desired location. The size of the overlay 720 may also be adjusted based on input received on the overlay. The transparent application window 710 may also comprise a bring to front icon 713. A computing device may set a default policy that the second application window 700 may be a foreground application window and the transparent application window might not be a foreground application window (e.g., a background window). But a user may use the bring to front icon 713 to bring the transparent application window 710 to the front (e.g., a window of the first application may become a foreground application window) so that the window of the first application may become opaque and no longer transparent. The transparent application window 710 may also comprise a transparency level icon 716. The transparency level of the window of the first application may be determined based on a user preference (e.g., a transparency level set at the option 640) or may be adjusted by a user using the transparency level icon 716. Additionally or alternatively, the transparency level may dynamically or automatically change based on the content and/or the functionality in the second application window 700. For example, if the second application window 700 is associated with a Microsoft Excel application and the cells of the Excel application in the overlay 720 are blank (e.g., the cells do not contain any information), the transparency level may be set to be 10%. But if the cells in the overlay 720 are not blank (e.g., the cells contain texts), the transparency level may be set to be higher than 10% (e.g., 90%).

The transparency of the overlay and/or the transparent application window may be configured using operating system APIs. For example, parameters such as SetLayeredWindowAttributes may be used to set the opacity of a window. This may also be set up as part of an API call (e.g., CreateWindowEx API call). A foreground window may be set using operating system APIs such as SetForegroundWindow. Another application window may be set as a modal window (e.g., a graphical control element subordinate to the transparent application window) so that the transparent application window is disabled but visible. A modal window may be set using operating system APIs parameters such as SetWindowPos functions. The SetWindowPos functions may comprise HWND_TOPMOST (e.g., the modal window maintains its topmost position even when it is deactivated), SWP_NOMOVE (e.g., retain the current position), and/or SWP_NOSIZE (e.g., retain the current size).

The icons 711, 712, 713, and 716 may be part of a different application (e.g., a third application) that controls the functions of the overlay 720 and/or the transparent application window 710. Additional icons and functions may be added.

The location of the transparent application window 710 and/or the overlay 720 may be determined based on the locations of the content items within the second application window 700 and the transparent application window 710. The second application window 700 may comprise a plurality of content items (e.g., actionable items) shown with solid lines. For example, as shown in FIG. 7A, the second application window 700 may comprise content items 701A-701E. The content item 701C may overlap with the overlay 720. The transparent application window 710 may comprise a plurality of content items shown in dashed lines. For example, the transparent application window 710 may comprise content items 702A-702C. The location of the transparent application window 710 and/or the overlay 720 may be determined based on the locations of the content items 701A-701E within the second application window 700 and the content items 702A-702C within the transparent application window 710. For example, the location of the transparent application window 710 and/or the overlay 720 may be determined such that the content items 701A-701E do not overlap with the content items 702A-702C. The overlay 720 may be positionable on the user interface and the position of the overlay 720 may be adjusted (e.g., moved up, down, left, or right) based on the content items 701A-701E and the content items 702A-702C. For example, if the default position of the overlay 720 may cause some overlap of the content items 701A-701E and the content items 702A-702C, the location of the overlay 720 may be adjusted to minimize the overlap, by, for example, determining the smallest possible overlapped area of the content items. Additionally, a size of the overlay 720 may be adjusted based on the content items 701A-701E and the content items 702A-702C to minimize the overlap of the content items. FIG. 7A shows an example of the location of the overlay 720, which is determined based on a determination (e.g., predication) that the content items 701A-701E will not overlap with the content items 702A-702C in the overlay 720. In this way, the overlay 720 might not block or otherwise obscure the visibility of any content within the second application window 700 and a user may easily view the content within both application windows.

A user may move a cursor 714 to the overlay 720 and may click one of the icons 711-713. The icons 711-713 may be specifically designed for the transparent application window 710 and any click of the icons 711-713 may cause the first application (e.g., application displayed within the overlay) to perform a corresponding function, and might not cause the second application to perform any operation. The locations of the icons 711-713 may dynamically change based on the second application window 700 such that the icons 711-713 do not overlap with any content (e.g., texts, images) within the second application window 700.

The overlay of the transparent application window 710 on the second application window 700 may provide a number of benefits and advantages. For example, the first application may output notifications (e.g., company announcements, new emails, new messages, stocks, weather forecast, traffic alerts, social media notifications) and activity feeds (e.g., reported ticket status change, paid time off (PTO) request approved, reported ticket status commented, new development of an application) such that a user may view them while operating on the second application window. In this way, the user might not need to switch windows or place two application windows side by side for viewing notifications or activity feeds while working on a different application.

FIG. 7B describes an example of visual indications associated with a transparent application window. After the overlay 720 is provided on top of the second application window 700, a visual indication 715 may be generated and output on the user interface. The visual indication 715 may comprise a bounding box that surrounds the transparent application window 710, and/or information indicating the click-through status of the overlay 720. For example, the visual indication 715 may comprise texts such as “click-through: on” to indicate whether any received user input on the overlay 720 will pass through the overlay 720 and cause the second application to perform an operation. The visual indication 715 may be provided at the top of the overlay 720. Additionally or alternatively, the visual indication 715 may be provided in relation to one or more content items or may be provided at any other suitable location, as long as the visual indication 715 does not hinder the visibility of the content shown within the overlay 720. One or more additional visual indications may be provided for one or more content items, and/or one or more groups of content items. For example, a visual indication may be provided for the content items 701C and 702C, as shown in FIG. 7B. Because the content items 701C and 702C are placed close to each other (e.g., or even overlapped in part or in whole), a visual indication may be output to indicate whether any user input will pass through the overlay 720 when a user selects the content item 701C, the content item 702C, or any other areas indicated by the visual indication.

The visual indication 715 may further comprise a toggle switch (e.g., a toggle button) that allows the user to choose between two click-through states (e.g., on and off). For example, by providing a toggle switch on the user interface, the user may easily determine and select whether a user input needs to be passed through the overlay 720. The toggle switch may allow the user to switch between two click-through modes. The first mode may be configured to enable input received on the overlay 720 to initiate operations of the second application, and the second mode may be configured to initiate operations of the first application included within the overlay 720 in response to input received thereon.

Additionally, a visual indication 717 may be output to highlight a user selection of a content item (e.g., the content item 702C) of the overlay 720. The visual indicator 717 may be generated based on a user preference (e.g., the option 680). The visual indicator 717 may comprise images, texts, pointers, shapes, and other types of indicator to highlight or otherwise emphasize the content item 702C that the user intends to select (e.g., move the cursor 714 to the content item 702C), so that the user knows in advance which content item will be selected and which application will perform a corresponding action based on the user input.

FIG. 7C describes an example of selecting a live subset of an application window to be the transparent application window. Based on the option 670, a user may determine manual or automatic selection of a subset or portion of the transparent application window. The manual selection of a subset or portion of the transparent application window may allow the user to select (e.g., capture) one or more items of interest of the transparent application window to be output. For example, as shown in FIG. 7C, a user may select a subset or portion of an application window 750 to be the transparent application window 710. A user may use a graphical control application (or a microapp, a widget), by selecting, for example, an icon 718, to select the subset of an application window 750. The user may draw a rectangular region based on the transparent application window 710, using the application. The subset of an application window 750 may be output in the top area of the transparent application window 710. After a user selects the subset of an application window 750, a third application that controls one of more icons 711, 712, 713, 716, and 718 may adjust the locations of the icons based on the location of the subset of an application window 750 (e.g., the icons may be placed below the subset of an application window 750). In this case, transparent window from resource application is acting as a proxy to take display portion region from first application and showing it as part of the transparent window. After the user selects the subset or portion of an application window 750, other areas of the transparent application window 710 might not be displayed, so as to minimize the content that the user does not wish to see.

FIG. 7D describes an example of an automatic output of a transparent application window. The second application window 700 may indicate an application that a user is currently using. While working on the second application window 700, the user may wish to launch a different application in a transparent fashion on the same user interface. For example, a user may be using a coding application that outputs an error code. The user may wish to search the description of the error code 730 in a different application (e.g., a web browser, a search application). The new application may be launched based on the user selection of the description of the error code 730 (e.g., select and right-click the description and select a search function). A user device may store information indicating the relationship between the coding application and the new application for one or more users. Based on the option 690 and/or stored user preferences, the new application may be output in a transparent fashion without any further user input (e.g., selection of the bring to front icon 713). For example, in FIG. 7D, the selection of the description of the error code 760 may prompt (e.g., automatically prompt) or cause the output of the transparent application window 710. The transparent application window 710 may be associated with a search application that allows the user to enter the error code and search the error code using the content item 702C, without adjusting the second application window 700 (e.g., minimizing the second application window 700 and switching to the search application).

Additionally, because the content items of the transparent application window 710 can be presented without overlapping with the content item of the second application window 700, a user's input on the content item 702C (e.g., a user conducts a search of the description of the error code) may initiate the operation of the search application. No click-through mode may need to be configured and a user may easily operate on two application windows on the same user interface.

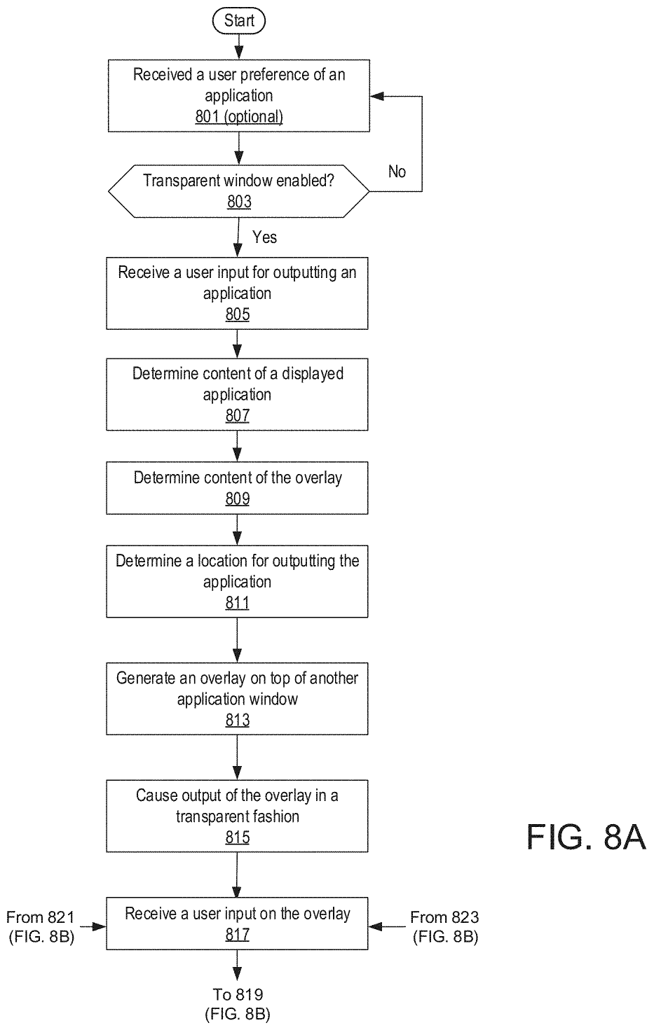

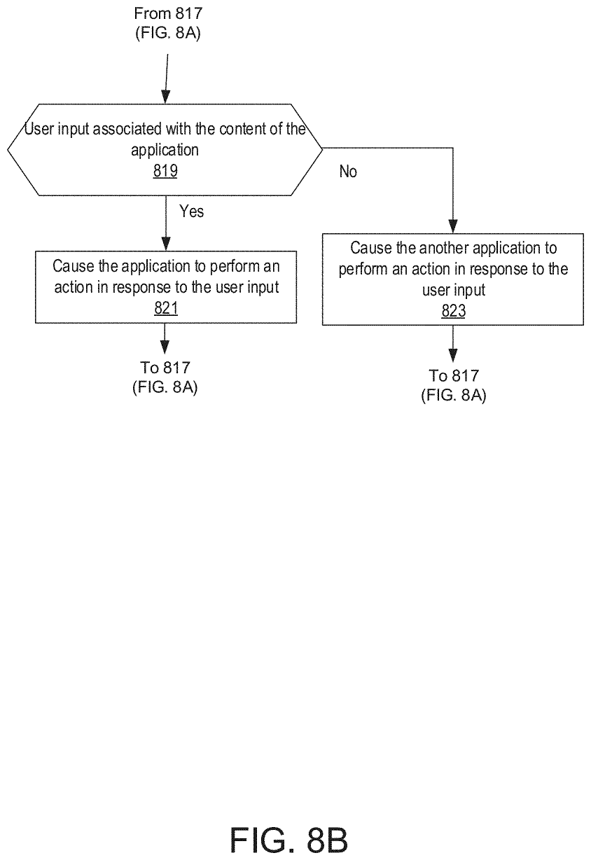

FIGS. 8A and 8B depict a flowchart showing an example method for providing transparent applications in accordance with one or more illustrative aspects described herein. The example method may be performed, for example, by one or more computing devices such as the client 202 or the terminals 240. The steps of the example method are described as being performed by particular computing devices for the sake of simplicity, but the steps may be performed by any other computing device.

In FIG. 8A, at step 801, a computing device may receive a preference of a user for an application. For example, the computing device may receive user preferences related to the transparency settings of an application. FIG. 6 shows an example user interface for obtaining user preferences of an application. As shown in FIG. 6, the user preferences may comprise whether transparent application window features are enabled, a transparency level of an application, smart placement of a transparent application window, smart click-through of a transparent application window, selection of a subset of a transparent application window, visual indication for selection of content of a transparent application window, and/or automatic generation of a transparent application window. The computing device may comprise a database for storing the user preferences for individual users or user accounts. This step may be optional. For example, a computing device may store default settings related to the transparent application window features, without receiving any input from a user.

At step 803, the computing device may determine whether the transparent application window features are enabled. For example, based on the user preferences received at step 801, the computing device may determine whether a user would like to enable the transparent application window features when viewing other applications. If the transparent application window features are not enabled, the application window might not be transparent and the method may then return to step 801.

At step 805, the computing device may receive a user input for displaying (e.g., outputting) an application. The user input may or may not indicate that the application should be output in a transparent fashion. Based on the stored user preferences (e.g., the option 690), the computing device may determine that the application should be output in a transparent fashion. The user input may be based on the content of a currently running application. For example, a user may select a link of another application, which causes the launch of an application.

At step 807, the computing device may determine the content of a displayed application (e.g., currently running application, the currently displayed application). The computing device may determine the content of a second application that is currently displayed on the user interface (e.g., the second application window 700). For example, the computing device may determine actionable items of the second application. For example, the computing device may determine actionable items based on role attributes in HTML elements (e.g., role=“button” means it is actionable, type of the element such as button, check box are actionable). Similarly UI automation may also be used to distinguish or identify actionable elements. The actionable items may receive user inputs, and other types of content shown on the user interface may not be able to receive user inputs. Additionally, the computing device may determine the location of the content of the second application. For example, the computing device may determine the location (e.g., coordinates, locations relative to other actionable items and/or the boundaries of the application window) of each of the actionable items of the second application. The computing device may determine the dimensions and/or locations of the content items being selected, using APIs (e.g., OS, user interface (UI) automation, DOM/HTML).

The computing device may comprise a computer vision image processing module (e.g., an image processing library such as OpenCV), which may be used to identify the content of the second application on the user interface. The screen image content of a foreground window (e.g., a window that the user is currently using, an active window) may be captured, and the texts and the color of the pixels of the captured image may be used to identify the types of the content (e.g., whether a content item comprises an actionable item). Additionally, image contours (e.g., lines along the boundary of an image that have the same intensity) may be used to identify one or more areas where controls and/or content exist. The computing device may also determine one or more empty spaces such as one or more white spaces based on the identified areas by, for example, marking off the identified areas. Additionally, the computing device may use machine learning techniques to determine or predict the location (e.g., coordinates) of the actionable items. Such techniques may involve training with use of a set of images (e.g., annotated images) using tools such as LabelImg or Labelbox and various data augmentation techniques. A number of epoch runs and a k-fold strategy may be used to help with the training, testing, and validation aspects of the machine learning model. Once the machine learning techniques have achieved an acceptable accuracy and precision level determined by, for example, a system administrator, the computing device may apply the machine learning model to determine the locations of the actionable items of the second application.

Additionally, user interface (UI) automation techniques (e.g., Microsoft UI Automation) may be used for determining the actionable items of the second application. For example, UI automation techniques may be used to identify large content and/or controls occupying a screen space and use computer vision on those spaces to identify one or more empty spaces. Additionally, object automation (e.g., Microsoft Office automation APIs) may be used to identify and process content and/or controls in the foreground window. For example, if the foreground window is associated with a Microsoft Excel application, using the Microsoft Office automation APIs, cells on the right side of an Excel application may be identified to be blank. Those cells may be used to place the transparent application window.

The computing device may further determine a density of the actionable items of the second application. For example, the computing device may determine and assign a score (e.g., a numerical level) for the density of the actionable items of the second application. The score may be determined based on the locations of the actionable items of the second application and/or a quantity of the actionable items in one or more regions of the application window.

At step 809, the computing device may determine the content of the overlay. Similar to the determination of the content of the second application at step 807, the computing device may determine the content of the overlay to be output on the user interface. For example, the computing device may determine actionable items of an application to be displayed within the overlay. The computing device may also determine the location of the content of the application. For example, the computing device may determine the location of each of the actionable items of the application. Additionally, the computing device may determine a subset or portion of content to be output based on user preferences (e.g., the option 670).

At step 811, the computing device may determine a location for outputting a transparent application window or overlay. For example, based on the user preferences received at step 801, the computing device may determine a location for outputting a transparent application window in relation to one or more other applications that are concurrently displayed on a user interface of the computing device (or a different computing device). In response to the application of the default rules (e.g., automatic determination of the location) to the location of the transparent application window, the computing device may determine the location of the transparent application window based on the content of the foreground window and/or the content of the transparent application window (e.g., the content of the second application determined at step 807, the content of the application determined at step 809). The transparent application window may be output on top of a portion of the foreground window so that the content of the transparent application window does not overlap with at least a substantial portion of the content of the foreground window. For example, the location for outputting a transparent application window may be determined based on a prediction that the content (e.g., actionable items) of the transparent application window will not overlap with the content (e.g., actionable items) of the foreground window.

One or more regions of interests for placing the transparent application window may be determined based on the determined actionable items of the foreground window and the transparent application window. For example, a first density of the actionable items of the foreground window and a second density of the actionable items of the transparent application window may be determined. Additionally, density scores for different regions of the foreground window and the transparent application window may be calculated. One or more regions of interests may be determined based on a comparison of the first density and a second density, and/or comparisons of the density scores. For example, in FIG. 7A, the computing device may determine that the left portion of the second application window 700 has a higher density of actionable items (assuming content items 701A-701E are actionable items) than the right portion of the second application window 700. The computing device may determine a low-density score for the right portion of the second application window 700, and a high-density score for the left portion of the transparent application window 710. The computing device may determine a region of interest for the transparent application window 710 by matching a first region of the transparent application window 710 with a high-density score and a second region of the second application window 700 with a low-density score. In this way, the overlap between the actionable items of the transparent application window 710 and the second application window 700 may be minimized, if not eliminated entirely.

Additionally, for different regions of interest, the overlapped areas of actionable items from the transparent window and the foreground window may be adjusted. For example, a size of the transparent application window may be adjusted based on the overlapped areas of the actionable items. As an example, a size of the transparent application window may be enlarged or shrunk such that one more previously overlapped actionable items may no longer overlap with actionable items of the foreground window. The adjustments may be determined based on the coordinates and/or dimensions of one or more of the actionable items.

For example, if the transparent application window is a browser window, the size of the browser window may be adjusted so that the size of content within the browser window may be automatically adjusted. The browser application may render the document object model (DOM) content of the second application in a WebView control owned by the browser application. The browser application may perform the rendering in a hidden fashion, for example, by not showing the WebView initially where it varies the size. The browser application or the computing device may render the DOM content and perform the overlap/density analysis to identify the best size of the browser application. Once the browser application or the computing device has determined the best size of the browser application, the browser application may switch the visible attribute from hidden to show for the WebView control. Any user input on this adjusted size in the WebView control may need to be sent to the appropriate control/location in the actual browser application.

Additionally, the content within the overlay may be rearranged based on the content of the transparent application window and/or the content of the foreground window, while the size of the overlay or the transparent application window may remain the same. For example, the content within the overlay may be reduced (e.g., only output some of the actionable items) to minimize the overlap between the actionable items of the transparent application window 710 and the second application window 700.

At step 813, the computing device may generate an overlay on top of another application window (e.g., the foreground application window). For example, based on the determined location of the transparent application window, the computing device may generate an overlay that is in a transparent fashion on top of another application window. The overlay may be the same as the transparent application window or may comprise only a portion of the application window.

At step 815, the computing device may cause output of the overlay in a transparent fashion. The computing device may place the transparent application window at the determined location and may concurrently output the transparent application window and another application window. The overlay may overlap with at least a portion of another application window. The screen content of the transparent application window may be refreshed and synced periodically. In some examples, a user may select a click-through status by turning on or off a click-through status indicator (e.g., select the visual indication 715).

At step 817, the computing device may receive a user input on the overlay. The user input may comprise, for example, a click on a blank space of the overlay, a click on a specific icon (e.g., one of the icons 711-713) of the transparent application window, a click on a content item of the transparent application window, or a click on a content item of another application window visible yet beneath the overlay. The computing device may perform different actions based on the user input and/or the content associated with the user input.

Referring to FIG. 8B, at step 819, the computing device may determine whether the user input is associated with the content of the transparent application window. Because the location of the transparent application window is determined to minimize the overlap with the content of another application window, the computing device may recognize whether the user input is intended for a content item of the application. For example, based on the location of the user input (e.g., a user clicks on a content item on the overlay), a user device may determine that the user input intends to cause a second application associated with the another application window to perform an operation, the user device may pass through or otherwise transmit the user input from the transparent application window to the another application window and cause the second application to perform an operation based on the user input. Alternatively, the computing device may determine whether the user input is associated with the content of the transparent application window based on the click-through status (e.g., on or off). If the click-through status is on, the computing device may determine that the user input is not associated with the content of the transparent application window based on the click-through status. Instead, the computing device may determine that the user input is associated with the content of the another application window visible beneath the overlay that includes the another application. If the click-through status is off, the computing device may determine that the user input is associated with the content of the transparent application window.

At step 821, the computing device may cause the application to perform an action in response to the user input. For example, if the computing device determines that the user input is associated with the content of the transparent application window, the computing device may cause the application included within the overlay to perform an action in response to the user input. The computing device may cause the application to respond to the user input, and might not pass through the user input to the another application visible beneath the overlay. The method may then proceed to step 817.

At step 823, the computing device may cause the another application included within a window beneath the overlay to perform an action in response to the user input received on the overlay. For example, if the computing device determines that the user input is not associated with the content of the transparent application window, the computing device may cause the application within the window below the overlay to perform an action in response to the user input received on the overlay. Based on the user input, the computing device may pass through user input (e.g., the mouse events) to the application in the window located beneath the overlay. For example, referring to FIG. 7A, if a user clicks on the content item 701C in the transparent application window 710, the mouse event(s) may pass through to the second application window 700. This may be achieved in various ways. For example, the computing device may set an extended windows style (e.g., set a WS_EX_TRANSPARENT bit set such as 0x00000020L) for the application. This extended window style may ignore the mouse events and may pass the mouse events on the overlay to the second application window 700 underneath the overlay 720. As another example, the computing device may forward the mouse events from the overlay 720 to the second application window 700. The application may capture the location of the click and the click type. The application may send the same mouse click events to the second application window 700. The application of the overlay 720 may monitor what window is underneath the overlay 720 and send the mouse events to the window underneath. As another example, the computing device may set a hook (e.g., a point in the system message such as SetWindowsHook) that can hook the mouse events for the application and then post a message to the second application window 700. The message may comprise information indicating the mouse events. The method may then proceed to step 817.

The following paragraphs (M1) through (M13) describe examples of methods that may be implemented in accordance with the present disclosure.

(M1) A method comprising: generating, by a computing device, an overlay that is transparent and positionable on top of a window of a user interface, the overlay including visible content of an application different than another application of the window; based on the visible content of the application and content of the another application, determining a location of the overlay relative to the window; and providing, based on the determined location, the overlay on top of the window, so as to display the visible content of the application in a nonoverlapping fashion with the content of the another application to display and enable use of multiple applications with one window.

(M2) A method may be performed as described in paragraph (M1) further comprising receiving an input on the overlay, the received input being intended for an element of the content of the another application displayed within the window and visible through the overlay; determining the element of the content of the another application based on the received input; and causing the another application to perform an operation based on the user input.

(M3) A method may be performed as described in either paragraph (M1) or (M2) wherein the determining comprises: determining the location of the overlay based on locations of a plurality of actionable elements of the another application, wherein each of the plurality of actionable elements includes one of a link, a button, a navigation control element, a selectable item, or an input field.

(M4) A method may be performed as described in any of paragraphs (M1) through (M3) further comprising: capturing an event indicative of movement of a pointer on the user interface; determining that the event involves an element on the overlay; and providing, based on the determination that the event involves the element on the overlay, a visual cue indicative of a potential selection of the element.

(M5) A method may be performed as described in any of paragraphs (M1) through (M4) further comprising: receiving a user input for outputting the application executable on the computing device, wherein the generating is based on the user input.

(M6) A method may be performed as described in any of paragraphs (M1) through (M5) further comprising: based on a user preference associated with the application or based on the content of the another application, selecting a subset of a window of the application to be the overlay.

(M7) A method may be performed as described in any of paragraphs (M1) through (M6) further comprising: based on additional content of the another application, determining an updated location of the overlay relative to the window; and providing the overlay on top of the window at the determined updated location.

(M8) A method comprising: determining, by a computing device, a location of an overlay on top of a window displayed within a user interface based on content of an application accessible via the overlay and based on content of another application different from the application, the window including the content of the another application; providing the overlay at the determined location, the overlay being transparent and including the content of the application; receiving an input on the overlay, the received input being intended for an element of the content of the another application displayed within the window and visible through the overlay; determining an element of the content of the another application based on the received input; and providing an instruction to the another application, the instruction to replicate an input received on the determined element of the content of the another application to initiate the another application to perform an action.

(M9) A method may be performed as described in paragraph (M8) wherein the determining the location of the overlay comprises: determining the location of the overlay based on locations of a plurality of actionable elements of the another application, wherein each of the plurality of actionable elements includes one of a link, a button, a navigation control element, or an input field.

(M10) A method may be performed as described in either paragraph (M8) or (M9) further comprising: capturing an event indicative of movement of a pointer on the user interface; determining that the event involves an element on the overlay; and providing, based on the determination that the event involves the element on the overlay, a visual cue indicative of a potential selection of the element.

(M11) A method may be performed as described in any of paragraphs (M8) through (M10) further comprising: based on a user preference associated with the application or based on the content of the another application, selecting a subset of an window of the application to be the overlay.

(M12) A method may be performed as described in any of paragraphs (M8) through (M11) further comprising: receiving a user input for outputting the application executable on the computing device, wherein the providing is based on the user input.

(M13) A method may be performed as described in any of paragraphs (M8) through (M12) further comprising: receiving a second input on the overlay, the received second input being intended for an element of the content of the application displayed within the window; and initiating an operation from the application based on the second input.

The following paragraphs (A1) through (A7) describe examples of apparatuses that may be implemented in accordance with the present disclosure.

(A1) An apparatus comprising one or more processors; and memory storing instructions that, when executed by the one or more processors, cause the apparatus to generate an overlay that is transparent and positionable on top of a window of a user interface, the overlay including visible content of an application different than another application of the window; based on the visible content of the application and content of the another application, determine a location of the overlay relative to the window; and provide, based on the determined location, the overlay on top of the window, so as to display the visible content of the application in a nonoverlapping fashion with the content of the another application to display and enable use of multiple applications with one window.

(A2) An apparatus may be implemented as described in paragraph (A1) wherein the instructions that, when executed by the one or more processors, further cause the apparatus to: receive an input on the overlay, the received input being intended for an element of the content of the another application displayed within the window and visible through the overlay; determine the element of the content of the another application based on the received input; and cause the another application to perform an operation based on the user input.

(A3) An apparatus may be implemented as described in either paragraph (A1) or paragraph (A2) wherein the instructions that, when executed by the one or more processors, further cause the apparatus to: determine the location of the overlay further based on locations of a plurality of actionable elements of the another application, wherein each of the plurality of actionable elements includes one of a link, a button, a navigation control element, a selectable item, or an input field.

(A4) An apparatus may be implemented as described in any of paragraphs (A1) through (A3) wherein the instructions that, when executed by the one or more processors, further cause the apparatus to capture an event indicative of movement of a pointer on the user interface; determine that the event involves an element on the overlay; and provide, based on the determination that the event involves the element on the overlay, a visual cue indicative of a potential selection of the element.

(A5) An apparatus may be implemented as described in any of paragraphs (A1) through (A4) wherein the instructions that, when executed by the one or more processors, further cause the apparatus to receive a user input for outputting the application executable on the computing device, wherein the instructions, when executed by the one or more processors, cause the apparatus to generate the overlay based on the user input.

(A6) An apparatus may be implemented as described in any of paragraphs (A1) through (A5) wherein the instructions, when executed by the one or more processors, further cause the apparatus to select a subset of a window of the application to be the overlay based on a user preference associated with the application or based on the content of the another application.

(A7) An apparatus may be implemented as described in any of paragraphs (A1) through (A6) wherein the instructions, when executed by the one or more processors, further cause the apparatus to based on additional content of the another application, determine an updated location of the overlay relative to the window; and provide the overlay on top of the window at the determined updated location.

Although the subject matter has been described in language specific to structural features and/or methodological acts, it is to be understood that the subject matter defined in the appended claims is not necessarily limited to the specific features or acts described above. Rather, the specific features and acts described above are described as example implementations of the following claims.

1. A method comprising:
generating, by a computing device, an overlay that is transparent and positionable on top of a window of a user interface, the overlay including visible content of an application different than another application of the window;
based on the visible content of the application and content of the another application, determining a location of the overlay relative to the window;
providing, based on the determined location, the overlay on top of the window, so as to display the visible content of the application in a nonoverlapping fashion with the content of the another application to display and enable use of multiple applications with one window;
based on a determination that additional content is added to the another application, determining an updated location of the overlay relative to the window;
providing the overlay on top of the window at the determined updated location;
capturing an event indicative of movement of a pointer on the user interface;
determining that the event involves an element on the overlay; and
providing, based on the determination that the event involves the element on the overlay, a visual cue indicative of a potential selection of the element on the overlay.

2. The method of claim 1, further comprising:
receiving an input on the overlay, the received input being intended for an element of the content of the another application displayed within the window and visible through the overlay;
determining the element of the content of the another application based on the received input; and
causing the another application to perform an operation based on the user input.

3. The method of claim 1, wherein the determining comprises:
determining the location of the overlay based on locations of a plurality of actionable elements of the another application, wherein each of the plurality of actionable elements includes one of a link, a button, a navigation control element, or an input field.

4. (canceled)

5. The method of claim 1, further comprising:
receiving a user input for outputting the application on a display of the computing device, wherein the generating is based on the user input.

6. The method of claim 1, further comprising:
based on a user preference associated with the application or based on the content of the another application, selecting a subset of a window of the application to be the overlay.

7. (canceled)

8. An apparatus comprising:
one or more processors; and
memory storing instructions that, when executed by the one or more processors, cause the apparatus to:
generate an overlay that is transparent and positionable on top of a window of a user interface, the overlay including visible content of an application different than another application of the window;
based on the visible content of the application and content of the another application, determine a location of the overlay relative to the window;
provide, based on the determined location, the overlay on top of the window, so as to display the visible content of the application in a nonoverlapping fashion with the content of the another application to display and enable use of multiple applications with one window;
based on a determination that additional content is added to the another application, determine an updated location of the overlay relative to the window;
provide the overlay on top of the window at the determined updated location;
capture an event indicative of movement of a pointer on the user interface;
determine that the event involves an element on the overlay; and
provide, based on the determination that the event involves the element on the overlay, a visual cue indicative of a potential selection of the element on the overlay.

9. The apparatus of claim 8, wherein the instructions, when executed by the one or more processors, further cause the apparatus to:
receive an input on the overlay, the received input being intended for an element of the content of the another application displayed within the window and visible through the overlay;
determine the element of the content of the another application based on the received input; and
cause the another application to perform an operation based on the user input.

10. The apparatus of claim 8, wherein the instructions, when executed by the one or more processors, further cause the apparatus to:
determine the location of the overlay further based on locations of a plurality of actionable elements of the another application, wherein each of the plurality of actionable elements includes one of a link, a button, a navigation control element, or an input field.

11. (canceled)

12. The apparatus of claim 8, wherein the instructions, when executed by the one or more processors, further cause the apparatus to:
receive a user input for outputting the application on a display of the apparatus, wherein the instructions, when executed by the one or more processors, cause the apparatus to generate the overlay based on the user input.

13. The apparatus of claim 8, wherein the instructions, when executed by the one or more processors, further cause the apparatus to:
based on a user preference associated with the application or based on the content of the another application, select a subset of a window of the application to be the overlay.

14. (canceled)

15. A method comprising:
determining, by a computing device, a location of an overlay on top of a window displayed within a user interface based on content of an application accessible via the overlay and based on content of another application different from the application, the window including the content of the another application;
based on a determination that additional content is added to the another application, determine an updated location of the overlay relative to the window; and
providing the overlay on top of the window at the determined updated location, the overlay being transparent and including the content of the application;
receiving an input on the overlay, the received input being intended for an element of the content of the another application displayed within the window and visible through the overlay;
determining an element of the content of the another application based on the received input;
providing an instruction to the another application, the instruction to replicate an input received on the determined element of the content of the another application to initiate the another application to perform an action;
capturing an event indicative of movement of a pointer on the user interface;
determining that the event involves an element on the overlay; and
providing, based on the determination that the event involves the element on the overlay, a visual cue indicative of a potential selection of the element on the overlay.

16. The method of claim 15, wherein the determining the location of the overlay comprises:
determining the location of the overlay based on locations of a plurality of actionable elements of the another application, wherein each of the plurality of actionable elements includes one of a link, a button, a navigation control element, or an input field.

17. (canceled)

18. The method of claim 15, further comprising:
based on a user preference associated with the application or based on the content of the another application, selecting a subset of a window of the application to be the overlay.

19. The method of claim 15, further comprising:
receiving a user input for outputting the application on a display of the computing device, wherein the providing is based on the user input.

20. The method of claim 15, further comprising:
receiving a second input on the overlay, the received second input being intended for an element of the content of the application displayed within the window; and
initiating an operation from the application based on the second input.

21. The method of claim 1, wherein the additional content comprises a text or an image.

22. The apparatus of claim 8, wherein the additional content comprises a text or an image.

23. The method of claim 1, further comprising:
determining a click-through status of the overlay, wherein the click-through status is selected from the visual cue on the overlay; and
based on the click-through status, determining an appropriate application to perform an operation from the multiple applications.
